(19) United States
(12) Patent Application Publication
(10) Pub. No.: US 2026/0278116 A1
(43) Pub. Date: Sep. 17, 2026

(54) SECURITY ASSESSMENT SYSTEMS AND METHODS BASED ON ARCHITECTURAL MODELS OF SYSTEMS

(71) Applicants: GEORGE MASON UNIVERSITY, Fairfax, VA (US); BOARD OF REGENTS, THE UNIVERSITY OF TEXAS SYSTEM, Austin, TX (US)

(72) Inventors: Matthew Edmund JABLONSKI, Found Hill, VA (US); Duminda WIJESEKERA, McLean, VA (US); Gabriela CIOCARLIE, New York, NY (US)

(21) Appl. No.: 19/564,505

(22) Filed: Mar. 12, 2026

Related U.S. Application Data
(60) Provisional application No. 63/771,214, filed on Mar. 13, 2025.

(51) Int. Cl. G06F 21/57

(52) U.S. Cl. CPC G06F 21/577; G06F 2221/034

(57) ABSTRACT

An architectural model and a security verification library can be used to assess security of a system having multiple components. The architectural model can include communication interfaces, connections between the components, and one or more specifications. At least one aspect of the one or more specifications can be a behavior specification for security of the system. The security verification library can include a plurality of data structures that define actor profiles, techniques, and executable logic nodes for computing state transitions. The model can be annotated with one or more selections from the security verification library and subsequently evaluated. The evaluating can include verifying the annotated model with respect to the specification(s) by executing a formal proof over a symbolic state space of the annotated model. For example, the architectural model can be configured using Architectural Analysis and Design Language, and the system can be a cyber-physical system.

### CROSS-REFERENCE TO RELATED APPLICATION(S)

The present application claims the benefit of and priority under 35 U.S.C. § 119 (e) to and is a non-provisional of U.S. Provisional Application No. 63/771,214, filed Mar. 13, 2025, and entitled “Compositional Attack-Defense Modeling in Cyber-Physical Systems,” which is hereby incorporated by reference herein in its entirety.

### STATEMENT REGARDING FEDERALLY SPONSORED RESEARCH

This invention was made with government support under DE-EE0009046 awarded by the U.S. Department of Energy. The government has certain rights in the invention.

### FIELD

The present disclosure relates generally to security of systems susceptible to cyber attacks, and more particularly, to using architectural models to assess security of such systems, for example, cyber-physical systems.

### BACKGROUND

Cyber-physical systems (CPS) and complex computing architectures are increasingly prevalent in critical infrastructure, such as manufacturing and transportation systems. Securing these systems remains a concern, as vulnerabilities can lead to significant physical, financial, and data-related consequences. To mitigate these risks, system architects employ various modeling languages and assessment tools during the design phase to identify potential flaws and verify that components meet intended operational requirements. However, rigorous security testing is conventionally relegated to the later stages of the system development lifecycle when foundational design changes become prohibitively expensive and time-consuming. While some assessment techniques are deployed earlier in the design process, they often rely on static vulnerability scanning or localized simulation of specific, predefined attack paths. Such techniques often treat adversarial actions as isolated, stateless events, which may struggle to accurately account for the dynamic nature of modern threat actors. Embodiments of the disclosed subject matter may address one or more of the above-noted problems and disadvantages, among other things.

### SUMMARY

Embodiments of the disclosed subject matter provide security assessment systems and methods based on architectural models of systems. In some embodiments, a security verification library can be used to link actor behaviors (e.g., attacker(s), defender(s), etc.) to the design of a system in an architectural model, which can be configured, for example, using Architectural Analysis and Design Language (AADL). In some embodiments, the architectural model can be annotated with one or more data structures (e.g., representing actor attributes) from the security verification library, and the architectural model can be evaluated using a model checker, for example, to verify operation of the modeled system with respect to specifications defined as contracts (e.g., to confirm safety and/or liveliness of runtime processes within the modeled system). For example, attackers may affect safety or liveliness of the runtime processes, or defenders may need to stop the system in the presence of threats. Aspects of the disclosed subject matter can allow defensive capabilities to be evaluated early in the design process, for example, to ensure that defenders have the resources they need to be successful when the modeled system becomes operational.

In one or more embodiments, a security assessment method can comprise providing an architectural model of a system comprising a plurality of components. The architectural model may comprise communication interfaces, connections between the components, and one or more specifications. At least one aspect of the one or more specifications may be a behavior specification for security of the system. The security assessment method may further comprise providing a security verification library including a plurality of data structures that define actor profiles, techniques, and executable logic nodes for computing state transitions. The security assessment method may also comprise receiving annotations for the architectural model with one or more selections from the security verification library, and evaluating the annotated architectural model to assess security of the system. The evaluating may include verifying the architectural model with respect to the one or more specifications using a verification checker that executes a formal proof over a symbolic state space of the annotated architectural model.

In one or more embodiments, a security assessment system can include one or more processors, one or more databases, and one or more non-transitory media. The one or more databases may store a security verification library comprising a plurality of data structures that define actor profiles, techniques, and executable logic nodes for computing state transitions. The one or more non-transitory media may store computer-readable instructions that, when executed by the one or more processors, cause the one or more processors to (i) receive an architectural model of a system, (ii) receive input annotating the architectural model with one or more selections from the stored security verification library, and (iii) verify the annotated architectural model with respect to the one or more specifications by executing a formal proof over a symbolic state space of the annotated architectural model. The system being assessed may comprise a plurality of components, and the model thereof may include communication interfaces, connections between the components, and one or more specifications. At least one aspect of the one or more specifications may be a behavior specification for security of the system.

In one or more embodiments, one or more non-transitory computer readable media can store a security verification library. The security verification library may store a plurality of data structures defining actor profiles, techniques, and executable logic nodes for computing state transitions. The security verification library may be configured for use in annotating and evaluating an architectural model of a system. The system may comprise a plurality of components, and the model thereof may comprise a behavior specification for security of the system.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of a security assessment system, according to one or more embodiments of the disclosed subject matter.

FIG. 1B is a simplified schematic diagram illustrating aspects of a hierarchical arrangement of data structures of the security verification library, according to one or more embodiments of the disclosed subject matter.

FIG. 2A is process flow diagram illustrating aspects of a security assessment method, according to one or more embodiments of the disclosed subject matter.

FIG. 2B is process flow diagram illustrating aspects of another exemplary security assessment method, according to one or more embodiments of the disclosed subject matter.

FIG. 2C depicts a generalized example of a computing environment in which the disclosed technologies may be implemented.

FIG. 3A is a diagram of an exemplary architectural model for a computer numerical control (CNC) manufacturing system showing system hardware and connections.

FIG. 3B is a diagram of an exemplary architectural model for software running on a server for a CNC manufacturing system.

FIG. 4 illustrates aspect exemplary results for attacker and defender paths identified as a counterexample by a model checker.

FIG. 5A shows a first Backus-Naur Form (BNF) listing (Listing 1) for exemplary AGREE subclauses, according to one or more embodiments of the disclosed subject matter.

FIG. 5B shows a second BNF listing (Listing 2) for exemplary AGREE expressions, according to one or more embodiments of the disclosed subject matter.

FIG. 5C illustrates aspects of an exemplary first algorithm (Algorithm 1) for use in inserting a technique to a model configured in AADL, according to one or more embodiments of the disclosed subject matter.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted. As used herein, the use of “can” and “may” is intended to indicate that a particular recitation is optional.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Introduction

Disclosed herein are systems and methods for assessing security of a system (e.g., cyber-physical system) based on an architectural model thereof. The architectural model may serve as a formalized, machine-readable blueprint of the complex operational environment of the system, for example, by precisely defining the structural, behavioral, and semantic properties of the system. In some embodiments, the architectural model can include representations of the constituent computing components (e.g., hardware devices, software modules, or network nodes) of the system, the communication interfaces exposed by those components, and the physical or logical data connections that facilitate interaction between them. By capturing these elements in a formalized modeling language, the architectural model may allow system designers to mathematically express and evaluate complex system logic, data flows, and operational constraints long before physical hardware is manufactured or final application code is compiled. In some embodiments, the architectural model can be configured using Architectural Analysis and Design Language (AADL).

In some embodiments, a security verification library is provided for use with the architectural model in assessing security of the system. For example, the security verification library can store data structures that define available actor profiles (e.g., attacker, defender, etc.) and their underlying capabilities, techniques for the different actors (e.g., individual actions or procedures that have pre-conditions or prerequisite capability requirements, and/or individual actions or procedures that provide post-outcome changes to the actor, such as credentials or information), and executable logic nodes for computing state transitions. Unlike conventional techniques that rely on text descriptions for human analysts, the data structures stored by the security verification library may provide tactic, techniques, and procedures (TTPs) for the different actors as formalized logical constraints (e.g., mathematical logic) that can be processed by a verification checker (also referred to herein as a model checker) to provide a formal proof over a symbolic state space of the architectural model.

In some embodiments, actor behaviors can be linked to the architectural model by annotating the model with constraints (e.g., based on the data structures from the security verification library), and the annotated architectural model may be evaluated by the verification checker, for example to verify operation of the system with respect to one or more security specifications (e.g., written as a contract for verification in Assume-Guarantee Reasoning Environment (AGREE)). For example, the constraints applied to the architectural model from the security verification library may be used by the verification checker to verify an actor's status at a time, t, against the predefined pre-conditions and to update the actor object at the next time increment, t+1. In some embodiments, this event chaining by the verification checker can create a hierarchical relationship of events to play out some risk scenario and validate security objectives (e.g., system safety and/or liveliness guarantees).

In some embodiments, the architectural model (e.g., reflecting the system design) with annotations (e.g., reflecting a potential attack/defense scenario) from the security verification library can be provided along with a desired specification (e.g., a security and/or safety contract for operation of the system), and the annotated model can be evaluated by executing a formal proof over a symbolic state space of the annotated architectural model, for example, to mathematically solve for a failure state with respect to the desired specification. For example, the verification checker can explore every mathematically possible combination of inputs and actions, subject to the annotated constraints, at each time step to find a counterexample to the specification in order to verify whether the system can withstand active execution of a threat. Accordingly, unlike conventional approaches that rely on static identification of threat susceptibility, embodiments of the disclosed subject matter may provide an assessment that more accurately reflects dynamic actor behaviors. Moreover, unlike conventional approaches that rely on simulation, embodiments of the disclosed subject matter can offer a quantitative formal proof with respect to the designated specification.

Embodiments of the disclosed subject matter may allow a user (e.g., system designer, security assessment team, analyst, etc.) to conduct a security assessment for risk scenarios that may otherwise have not been considered until later in the system development lifecycle. Such early assessments may allow for security enhancements and other design changes to be made to the system at a time when such changes may be less costly and/or easier to accommodate. In addition, in some embodiments, the architectural model can evolve with the system as components are selected or changed over the system development lifecycle (SDLC), and/or once the system is operationally deployed, thereby allowing further assessments to be performed and security formally verified throughout the SDLC. Embodiments of the disclosed subject matter may also contribute to a game theoretic analysis of system security, for example, to improve defense-in-depth requirement gathering and/or planning during the SDLC.

Furthermore, embodiments of the disclosed subject matter may provide specific, technical improvements to the functioning of computing systems utilized for security assessment and formal verification. Conventional security simulation systems often succumb to combinatorial state-space explosion when attempting to model dynamic, multi-step adversarial behaviors, thereby consuming computationally prohibitive amounts of memory and processing cycles. The systems and methods described herein overcome this technical hurdle by utilizing a specialized security verification library (e.g., comprising hierarchically structured data, bounded atomic variables, and executable logic nodes configured to perform semaphore-based, game-theoretic state updates). In some embodiments, the data structures stored by the security verification library may strictly bound the symbolic state space and may prevent logic collisions during concurrent event evaluation. Consequently, the memory footprint and computational overhead required by the verification checker may be significantly reduced, thereby enabling the computing system to execute an exhaustive formal mathematical proof over complex system architectures faster and more efficiently than conventional brute-force simulation tools.

Embodiments of the disclosed subject matter can be used to assess security by verifying correct performance or finding faults in operation of any cyber-physical system (CPS), such as but not limited to manufacturing systems, power generation and distribution, medical devices and infrastructure, civil infrastructure, agricultural systems, and vehicles. While the description herein may focus on CPS, embodiments of the disclosed subject matter are not limited thereto. Rather, the security assessment systems and methods described herein may be applied to a wide variety of architectural models representing diverse operational environments. By way of example and not limitation, the architectural model may represent a general computing system, a cyber system, a purely software-based architecture (e.g., a cloud computing environment or microservices architecture), an enterprise information technology (IT) network, a financial transaction system, a telecommunications network, an Internet of Things (IoT) network, or a complex system of systems (SoS). In such embodiments, the specifications and executable logic nodes evaluated by the verification checker may monitor data state transitions, network routing privileges, software vulnerabilities, or logical constraints, in addition to or in place of physical hardware states.

### Security Assessment Systems

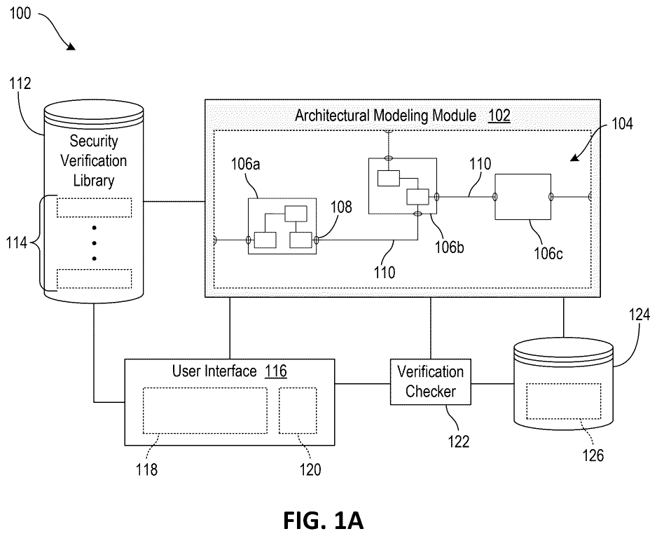

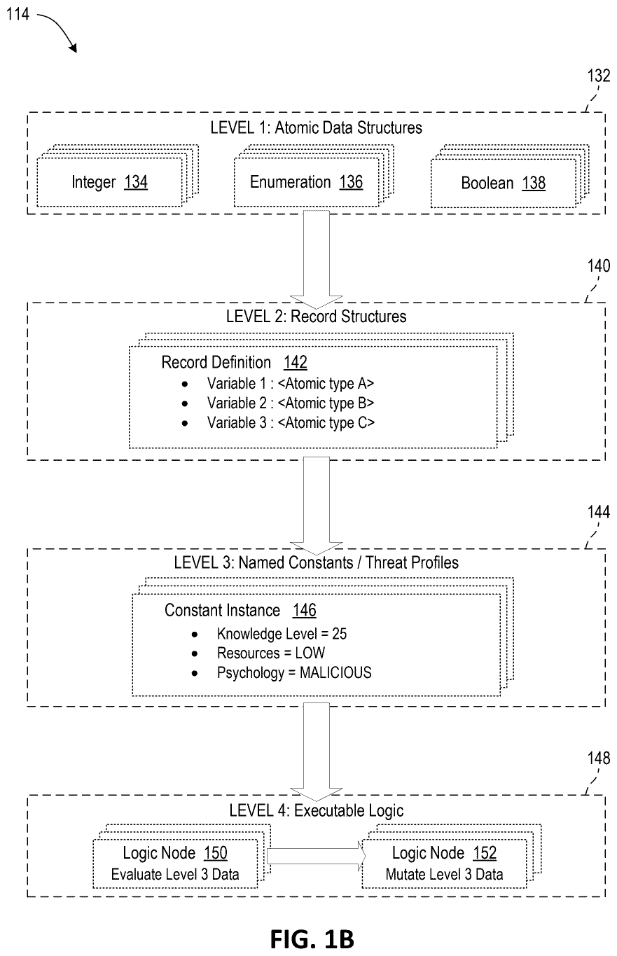

FIG. 1A shows an example configuration for a security assessment system 100. In the illustrated example, system 100 includes an architectural modeling module 102, a security verification library 112, a user interface module 116, a verification checker 122, and a specifications module 124. However, fewer or more components may be provided in other systems according to one or more contemplated embodiments. Moreover, although certain functions and operations are discussed below as being associated with particular components, functions/operations can instead be performed by other components and/or be shared between components according to one or more contemplated embodiments. Accordingly, embodiments of the disclosed subject matter are not limited to the specific configuration illustrated in FIG. 1A.

In some embodiments, software components, applications, routines or sub-routines, or sets of instructions for causing one or more processors to perform certain functions may be referred to as “modules” or “engines.” It should be noted that such modules or engines, or any software or computer program referred to herein, may be written in any computer language and may be a portion of a monolithic code base, or may be developed in more discrete code portions, such as is typical in object-oriented computer languages. In addition, the modules or engines, or any software or computer program referred to herein, may in some embodiments be distributed across a plurality of computer platforms, servers, terminals, and the like. For example, a given module or engine may be implemented such that the described functions are performed by separate processors and/or computing hardware platforms. Further, although certain functionality may be described as being performed by a particular module or engine, such description should not be taken in a limiting fashion. In other embodiments, functionality described herein as being performed by a particular module or engine may instead (or additionally) be performed by a different module, engine, program, sub-routine or computing device without departing from the spirit and scope of the invention(s) described herein.

It should be understood that any of the software modules, engines, or computer programs illustrated herein may be part of a single program or integrated into various programs for controlling one or more processors of a computing device or system. Further, any of the software modules, engines, or computer programs illustrated herein may be stored in a compressed, uncompiled, and/or encrypted format and include instructions which, when performed by one or more processors, cause the one or more processors to operate in accordance with at least some of the methods described herein. Of course, additional and/or different software modules, engines, or computer programs may be included, and it should be understood that the examples illustrated and described with respect to the figures herein are not necessary in any embodiments. Use of the terms “module” or “software engine” is not intended to imply that the functionality described with reference thereto is embodied as a stand-alone or independently functioning program or application. While in some embodiments functionality described with respect to a particular module or engine may be independently functioning, in other embodiments such functionality is described with reference to a particular module or engine for ease or convenience of description only and such functionality may in fact be a part of, or integrated into, another module, engine, program, application, or set of instructions for directing a processor of a computing device.

In some embodiments, the instructions of any or all of the software modules, engines or programs described above may be read into a main memory from another computer-readable medium, such from a read-only memory (ROM) to random access memory (RAM). Execution of sequences of instructions in the software module(s) or program(s) can cause one or more processors to perform at least some of the processes or functionalities described herein. Alternatively or additionally, in some embodiments, hard-wired circuitry may be used in place of, or in combination with, software instructions for implementation of the processes or functionalities described herein. Thus, the embodiments described herein are not limited to any specific combination of hardware and software.

Returning to FIG. 1A, the security assessment system 100 can be configured to evaluate an annotated architectural model to assess the security of a system, for example, by verifying the annotated architectural model with respect to one or more specifications. The architectural model 104 of a system can be provided by (e.g., built in) architectural modeling module 102. In some embodiments, the architectural model 104 can be configured using and/or defined in AADL. The architectural model 104 may provide a representation of the different components of the system being modeled and the operational relationships therebetween. For example, the system being modeled may be a cyber-physical system (CPS) having hardware (e.g., controller(s) and/or actuator(s)) and software. In the illustrated example of FIG. 1A, the architectural model 104 includes system components 106a-106c, communication interfaces 108 (only one of which is explicitly labeled), and connections 110 (e.g., data connections) between the components.

In some embodiments, the security verification library 112 can include a plurality of data structures 114 that are used to annotate the architectural model 104 in performing a desired security assessment. For example, the security verification library 112 can be configured as an AADL extension comprising an Assume-Guarantee Reasoning Environment (AGREE) annex. In some embodiments, the data structures 114 can define actor profiles, techniques, and executable logic nodes for computing state transitions. In some embodiments, at least some of the data structures 114 can provide a deterministic translation of actor behaviors into mathematical or logical constraints. For example, the data structures 114 can provide formalized behavior specifications that define the tactics, techniques, and procedures (TTPs) of specific actors. In some embodiments, the actor profiles may include one or more different threat actor profiles (e.g., attempting to attack a component), and/or one or more different defensive actor profiles (e.g., defending against an attack). In some embodiments, the data structures 114 may include quantified variables modeling the knowledge, resources, psychology, and capabilities of each actor. In some embodiments, the data structures 114 for a specific action may include a precondition (e.g., a prerequisite) required for performing the specific action, and/or a characteristic (e.g., knowledge, resource, or capability) obtained after performing the specific action. In some embodiments, the data structures 114 may also include one or more security properties of a component.

In some embodiments, an operator (e.g., system designer, security team, analyst, etc.) may interact with the system 100 via user interface 116. In the illustrated example, user interface 116 includes one or more input/output devices 120 (e.g., mouse, keyboard, etc.) and a display 118, for example, for viewing the architectural model 104, making changes and/or annotations thereto, and/or reviewing results of the security assessment (e.g., from verification checker 122).

In some embodiments, the specifications module 124 can include one or more specifications 126, and the architectural model 104 can be evaluated by the verification checker 122 with respect to at least one of those specifications 126. In some embodiments, the specifications 126 can include behavior specifications defining the required security and/or safety performance of the modeled system. In some embodiments, the specifications 126 can be defined as a contract. As used herein, the terms “contract,” “contract-based specification,” or “specification defined as a contract” do not refer to a legal agreement, a financial transaction, or a business method. Rather, in the context of system architecture and formal verification (such as Design by Contract or Assume-Guarantee reasoning), a contract-based specification refers to a formalized, machine-readable set of logical constraints governing the behavior of a system component. In some embodiments, a specification written as a contract defines the expected interactions between a component and its environment, for example, by defining one or more “Assumptions” (e.g., preconditions or required states of incoming data or the system environment) and one or more “Guarantees” (e.g., postconditions, safety boundaries, or promised outputs of the component provided the assumptions are satisfied).

During evaluation, the verification checker 122 can mathematically analyze these specifications against the defined state space to prove whether the system logic holds true under the modeled conditions. Assume and guarantee statements may be recursively constructed utilizing Boolean expressions, and logical combinations thereof. In some embodiments, the verification checker 122 can uses these contract-based specifications to either prove the guarantees are valid or to produce counterexamples in the form of attack/defense paths affecting safety or liveliness. For example, the verification checker 122 can verify the architectural model 104 (with annotations from security verification library 112) by executing a formal proof over the symbolic state space. In some embodiments, this formal proof can include performing a game-theoretic state update for each actor in the annotated architectural model at each time step. In some embodiments, the verification checker 122 may utilize a k-induction based model checker (e.g., JKind, Kind2, etc.). For example, to evaluate the model, an AGREE engine (e.g., provided by module 102) can translate the annotated architectural model 104 (e.g., in AADL) and associated specifications (e.g., from module 124) into Lustre code and then queries the verification checker 122 (e.g., JKind model checker) to perform verification using k-induction. For example, JKind invokes a back-end Satisfiability Modulo Theories (SMT) solver (e.g., Z3) to mathematically validate if the assumptions and guarantees hold. If a guarantee fails, the verification checker 122 may identify the possible violations, for example, by generating the full path of the attacker. Alternatively, a successful proof by verification checker 122 may determine that a violation of a specification is logically impossible under the modeled configurations.

In some embodiments, the data structures 114 may employ a hierarchical arrangement, for example, to facilitate the modeling of complex systems. FIG. 1B illustrates an exemplary hierarchical arrangement of data structures 114, where the different structures have been organized into four tiers or levels. In some embodiments, the security verification library can use such a four-layer data hierarchy to provide the data structures and predicates for modeling threats, vulnerabilities, and consequences thereof and evaluating security risks presented through operational scenarios within a system model (e.g., developed using AADL).

At the first level 132, the hierarchy includes a first set of atomic data structures that can define quantitative properties, for example, for modeling attacks and defenses within system 100 (e.g., the capabilities of attackers and defenders). In some embodiments, the atomic data structures of the first level 132 can include primitive data types, such as bounded integers 134 (e.g., a scale of 0 to 100, representing a threat actor's network knowledge), enumerations 136 (e.g., a discrete set of resource levels, such as Low, Medium, or High), and Boolean values 138 (e.g., true/false values reflecting the status or presence of a particular characteristic).

In some embodiments, dimensions of knowledge, resources, and psychology can be used to characterize actor profiles. In some embodiment, sub-dimensions can be provided within each of these dimensions, for example, to quantify relevant information included in actor profiles. For example, Table 1 below provides a listing of exemplary data structures for the first level 132, and associated properties and potential values. In Table 1, the first two columns represent dimension and sub-dimension, the third column describes whether the sub-dimension can be used by a particular higher-level data structure (e.g., Attacker, Defender, or both) in behavioral scenarios based on modeling offensive and defensive operations, the fourth column represents the data type, and the fifth column provides possible values.

TABLE 1
Sub-dimensional properties and possible values.

| Dimension | Sub-dimensions | Applicable | Type | Possible Values |
|---|---|---|---|---|
| Knowledge | [Off/Def]_K | Attack or Defend | Integer | [0-100] |
| | Physical_[Off/Def]_K | Attack or Defend | Integer | [0-100] |
| | Network_[Off/Def]_K | Attack or Defend | Integer | [0-100] |
| | Software_[Off/Def]_{—} | Attack or Defend | Integer | [0-100] |
| | Component_K | | | |
| | Protocol_{—} | Attack or Defend | Integer | [0-100] |
| | Component_K | | | |
| | Source_Code_{—} | Attack or Defend | Integer | [0-100] |
| | Component_K | | | |
| | Credential_{—} | Attack or Defend | Enumeration | None, user, admin., |
| | Component_K | | | SYSTEM_access, root, any |
| | | | | remote_desktop_users |
| Resource | Distance_R | Attack or Defend | Enumeration | none, far, near, any physical |
| | | | | access |
| | Manpower_R | Attack or Defend | Enumeration | low, medium, high |
| | [Off/Def]_Tools_R | Attack or Defend | Enumeration | basic, intermediate, advanced |
| | Financial_R | Attack or Defend | Integer | [0-1000000] |
| | Effort_R | Attack or Defend | Enumeration | low, medium, high |
| Psychology | Off_Aim_P | Attack | Enumeration | knowledge, manipulation, |
| | | | | disrupt, damage |
| | Def_Aim_P | Defend | Enumeration | none, all, confidentiality, |
| | | | | integrity, availability |
| | [Off/Def]_Physical_{—} | Attack or Defend | Enumeration | none, all, confidentiality, |
| | Sec_Aim_P | | | integrity, availability |
| | [Off/Def]_Virtual_{—} | Attack or Defend | Enumeration | none, all, confidentiality, |
| | Sec_Aim_P | | | integrity, availability |
| | Periodicity_P | Attack or Defend | Enumeration | once, any time, continuous |
| | Determination_P | Attack or Defend | Enumeration | first attempt, several attempts, |
| | | | | untiring |
| | Honesty_P | Attack | Enumeration | malicious, benign |
| | Camouflage_P | Attack or Defend | Enumeration | visible, stealthy, invisible |
| | Off_Strategy_P | Attack or Defend | Enumeration | random, brute force, structured |
| | Def_Strategy_P | Defend | Enumeration | random, monitor, investigate, |
| | | | | evict |

With respect to the listed sub-dimensions in Table 1, effort, periodicity, and determination may provide different aspects related to the timing of some action. For example, effort may represent how deeply the attacker or defender may try to attack or defend the system respectively, determination may be the duration of each activity, and periodicity may be the distribution of actions over time. As the disclosed techniques may be applied for compositional verification of a system, some sub-dimensions may include the term component within their name, for example, to indicate that the subdimension variable may be considered within component-specific objects to represent or measure the attacker or defender's knowledge regarding a specific component within architectural model. In some embodiments, protocol and source code knowledge may be a variable that is best considered for the attacker or defender regarding knowledge to some specific software sub-component included within the architectural model. Thus, this component-layer dimension allows for a human modeler to consider dependencies within specific components, such as the case where an attacker may require more knowledge about the protocol or source code if this information is not widely available or is proprietary. Physical, network, and software knowledge sub-dimensions may be considered at the top-layer within the verification analysis to model attacker or defender profiles based on known models (e.g., nation state attackers, hacktivists, etc.).

Returning to the illustrated example of FIG. 1B, the hierarchy further includes a second level 140 of record structures building upon the first level 132, for example, by storing entity definitions as structures aggregating the atomic data from the first level 132 into entity definitions. In some embodiments, the data structures of the second level 140 may be record structures 142 for use in the model, for example, defining attackers, defenders, their techniques and weaknesses, and security controls placed on system components. In some embodiments, each record structure 142 (e.g., declared as a struct in an AGREE annex) can act as a template or entity definition that aggregates one or more of the atomic data structures 134-138. For example, a “Threat Actor” record structure may be defined to mandate that any instantiated actor must possess specific variables for knowledge, resources, and psychology, all typed according to the atomic data structures from the first level 132.

In the illustrated example of FIG. 1B, the hierarchy further includes a set of constant instances 146 at the third level 144. In some embodiments, each constant instance 146 can be an instance of a record 142 from the second level 140 pre-configured based on a specific security standard (e.g., MITRE ATT&CK, MITRE D3FEND, NIST Frameworks, etc.) for tactics, techniques, and procedures (TTPs) of attackers/defenders. In some embodiments, the constant instance 146 can be a named constant which, through inheritance of the underlying record property 142, may allow an organization to develop rich data structure refinements for model initialization using previously developed security standards and frameworks. For example, an instance representing a “Cybercriminal” might populate the “Threat Actor” record structure with a knowledge integer of “25,” a resources enumeration of “LOW,” and a psychology enumeration of “MALICIOUS.”

In the illustrated example of FIG. 1B, the hierarchy further includes a set of logic nodes 150, 152 at the fourth level 148. In some embodiments, the logic nodes of the fourth level 148 can provide state transition relations or constraints for dynamic evaluation of the annotated architectural model by the verification checker. For example, during execution of a formal proof, logic nodes 150 can evaluate the stateful variables held within instances 146, and logic nodes 152 can mutate the stateful variables, thereby enabling the verification checker to model the evolving capabilities of actors across successive time steps. Alternatively, or additionally, in some embodiments, the data structures of the fourth level 148 can represent a combination of objects along with logic nodes (or functions) and specifications (e.g., AGREE contracts) attached to components in the model to dynamically and compositionally sequence and analyze attack and defense behaviors.

Returning to FIG. 1A, in some embodiments, the security verification library 112 can provide (e.g., by virtue of the stored data structures 114) an abstract model for attackers and defenders, as well as the process models they may utilize. In some embodiment, this abstraction can formulate the data model as an event-condition-action model utilizing predicate logic. For example, the resulting formulation can provide a formal model of the predicates, the process model, and model verification using assume/guarantee contracts. In some embodiments, such an abstract model can comprise at least: (1) a Player State Vector representing variables such as knowledge, resources, and psychology; (2) a Prerequisite Predicate (e.g., “CanPlay”) that compares the Player State to TTP Requirements; and (3) a State Mutation Function (e.g., “Play”) that updates the Player State and System State for a subsequent time step (t+1).

In some embodiments, within the abstract model, predicates can be used to represent an attacker or defender and their respective actions within the architectural model of the system. Terms used in predicates are typed, may be named, and may be inhibited by type variables and type constants. In some embodiments, the arithmetic operators (A1) can include <, ≤, =, ≥, and >. In some embodiments, a player predicate (A2, player) can be a predicate that represents an attacker or defender as a player. For example, the player predicate A2 can include an ordered set of typed variables (\vec{p^{know}}) representing the player's knowledge, resources, and psychology at the global and local levels, and an ordered set of typed variables (\vec{p^{cap}}) representing the player's capabilities. In some embodiments, a pre-action predicate (A3, preAct) can represent the knowledge, resource, psychology, and/or capability prerequisites required for specific actions, and post-action predicate (A4, postAct) can represent the knowledge, resources, and/or capabilities obtained after performing a specific action. In some embodiments, a component security predicate (A5, compSec) can represent security properties present within some component, to include defensive security controls, vulnerabilities and weaknesses, or data artifacts.

In some embodiments, the basic predicates (e.g., A1-A5) can be combined to define complex predicates that specify a player's ability to play under a pre-condition, as well as the capabilities gained by a player after their move. For example, the vector comparison \vec{x}>\vec{y} can be used as short hand for

$${⋁}_{i = 1 , j = i}^{i = n , j = m} ( {x}_{i} > {y}_{j} ) ,$$

where \vec{x} and \vec{y} are n- and m-ary vectors (x₁, . . . , xₙ) and (y₁, . . . , yₘ), respectively, and max (\vec{x}, \vec{y}) can be used as short hand for conducting a component-wise comparison of two vectors and returning the vector of maximum values from each comparison. Based on the defined short hand expressions and the basic predicates, more complex predicates for pre-condition (A6) and post-condition (A7) can be defined as follows:

$$A 6 : CanPlay ( i : ID , j : ID )$$

$$( preAct ( i , \vec{x} ) ∧ player ( j , \vec{{p}^{k n o w}} , \vec{{p}^{c a p}} ) ) ∧ ( \vec{{p}^{k n o w}} > \vec{x} ∨ \vec{{p}^{c a p}} > \vec{x} ) ; and$$

$$A 7 : Play ( i : ID , j : ID )$$

$$( postAct ( i , \vec{x} ) ∧ player ( j , t , \vec{{p}^{k n o w}} , \vec{{p}^{c a p}} ) ) ∧ player ( j , t + 1 , max \{ \vec{{p}^{k n o w}} , \vec{x} \} / \vec{{p}^{k n o w}} , max \{ \vec{{p}^{c a p}} , \vec{x} \} / \vec{{p}^{c a p}} ) .$$

Alternatively, or additionally, in some embodiments, predicates for a process model can include A8 and A9. For example, A8 can be a predicate proc (id:PID, \vec{x_{proc}}:\vec{PROC}) with typed attributes where id is a process identifier and \vec{x_{proc}} is a vector of process attributes belonging to a vector of types \vec{PROC}, and A9 represents process compositions defined where, if p₁, . . . , pₙ are processes, then so are pᵢ:pⱼ NdChoice (p₁, . . . , pₙ) and {P(s); pᵢ; V(s)} where P(s) and V(s) are “get” and “set” operations, respectively, of a semaphore s.

While the post-condition predicate (A7) may be understood to employ a temporal transition, it should be understood that this temporal transition is distinctly different from that employed in a conventional simulation, which executes a concrete instance of a transition (e.g., testing a single scenario). In contrast, the predicate employed in embodiments of the disclosed subject matter can define a symbolic constraint that governs all valid transitions, thereby allowing the verification checker to perform exhaustive mathematical proofs over the entire state space of the architectural model to determine if a violation of a specification (e.g., security and/or safety violation) is logically impossible (as opposed to merely empirically unobserved).

In some embodiments, the verification checker can employ assume and guarantee specifications to evaluate the architectural model. These specifications can reflect assumptions under which system components operate, as well as the safety or liveliness guarantees provided under specified attacker and defender actions. During evaluation, the verification checker can utilize these specifications to either mathematically prove that the guarantees are valid, or alternatively, to produce counterexamples. These counterexamples may take the form of specific attack or defense paths that may affect the safety or liveliness of the system. In some embodiments, the specification statements (e.g., assume-guarantee contracts) may be recursively constructed, for example, using any Boolean expression of the form xAc where A∈{<, ≤, =, ≥, >} may be an arithmetical comparison operator. Alternatively, or additionally, if A and B are individual statements, then the logical Boolean combinations of statements A and B may also be utilized to form a valid statement.

While the abstract model can provide a foundational first step in the verification process, in some embodiments, the system may be further configured to generate a refined attack-defense model. For example, concrete attackers and defenders may be modeled as distinct players within the system, where the abstract predicates represent, at a high level, some concrete series of action processes required to attack or defend the system. In some embodiments, to execute the formal proof, the architectural model may be refined to map these abstract predicates to concrete data structures (e.g., those utilized within the security verification library). For example, this refined model may utilize typed constants and variables as terms, similar to the abstract model. Alternatively, or additionally, the refined model may include predicates that specifically model entities, such as the attackers and defenders, as well as pre-actions and post-actions that may need to be executed prior to or post each play by these respective entities. In some embodiments, there may also be processes configured to execute a combination of attackers and defenders. Consequently, foundational abstraction statements (e.g., statements A1-A5) can be refined as actual attackers and defenders operating at the top-layers and component-layers of the architecture, along with their respective action prerequisite and post-outcome data structures, as well as the specific component-layer security properties.

### Security Assessment Methods

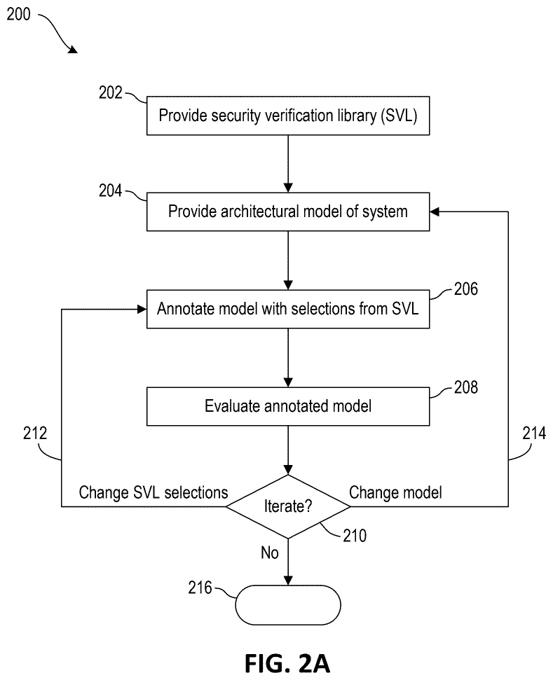

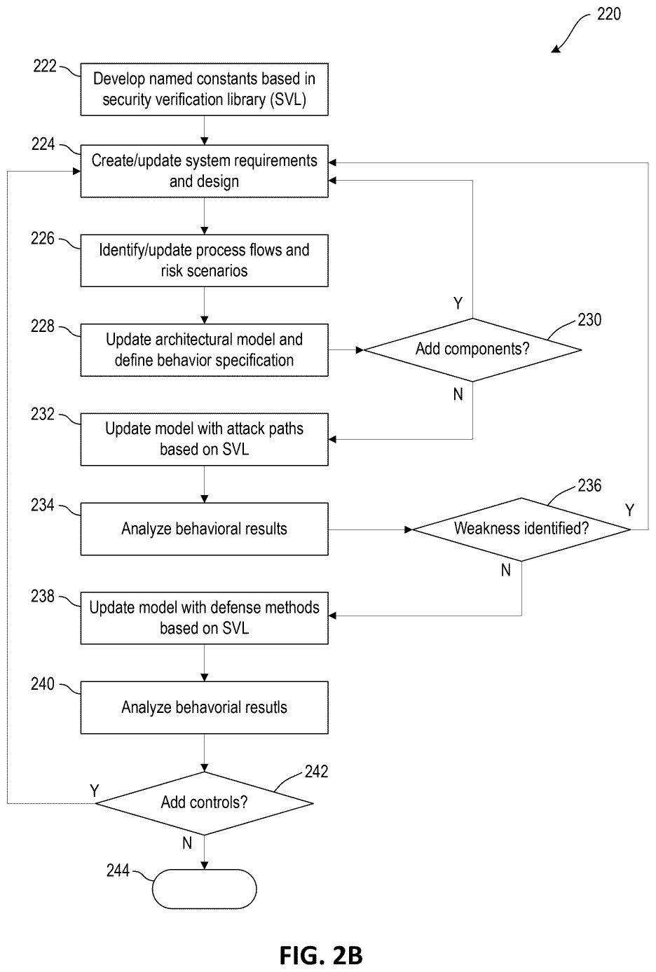

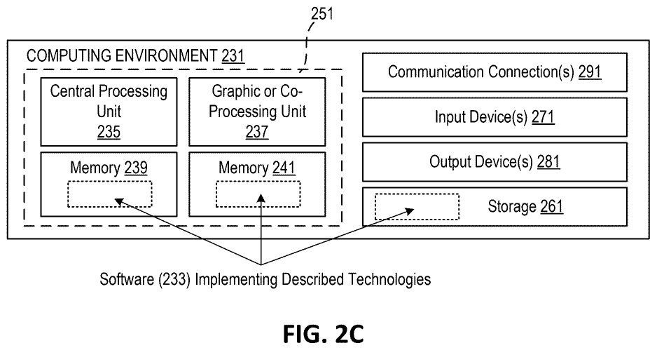

Referring to FIG. 2A, aspects of a method 200 for assessing security of a system are shown. The method 200 may initiate at process block 202, where a security verification library can be provided. In some embodiments, the security verification library can include a plurality of data structures that define actor profiles, techniques, and executable logic nodes for computing state transitions. In some embodiments, the security verification library can be configured as an AADL extension comprising an AGREE annex. In some embodiments, the providing of process block 202 can include customization of one or more data structures in the security verification library.

The method 200 may proceed to process block 204, where an architectural model of a system can be provided. In some embodiments, the system comprises a plurality of components, and the architectural model can include communication interfaces, connections between the components, and one or more specifications. In some aspects, the architectural model is configured using AADL. In some embodiments, at least one aspect of the one or more specifications can be a behavior specification for security of the system. In some embodiments, at least another aspect of the one or more specifications is with respect to safety of the system. In some embodiments, the specifications can be written as a contract (e.g., AGREE contract). In some embodiments, the providing of process block 204 can include building the architectural model (e.g., by defining the components and connections therebetween in appropriate modeling software) and/or drafting the specifications.

The method 200 may proceed to process block 206, where the architectural model can be annotated with one or more data structures selected from the security verification library. As used herein, annotating the architectural model refers to the process of binding formalized behavioral data to the structural components of the system model. For example, a system designer utilizing a user interface may select specific data structures from the library (e.g., particular threat actor profile, specific attacker techniques (TTPs), defender mitigation strategies, or assume-guarantee contracts) and may associate them with specific nodes, components, or communication interfaces within the architectural model.

In some embodiments, the annotations can reflect a particular threat scenario, for example, with one or more threat actors (“Attackers”) and/or one or more defensive actors (“Defenders”). In some embodiments, the annotations can be performed by different teams and/or at different times. For example, a “red team” can annotate the architectural model with data structures for an attacker, and a “blue team” can separately annotate the model with data structures for defensive techniques responsive to the attacker. In some embodiments, this annotation process can transform a static structural diagram into a dynamic state space capable of mathematical evaluation. For example, by injecting these executable logic nodes and contract-based specifications directly into the model, the annotations can provide the rigorous mathematical boundaries for executing a formal proof.

The method 200 may proceed to process block 208, where the annotated architectural model can be evaluated to assess the security of the system. In some embodiments, the evaluation of process block 208 can include verifying the annotated architectural model with respect to the one or more specifications, for example by using a verification checker that executes the formal proof over the symbolic state space of the annotated architectural model. In some embodiments, the formal proof can determine that violation of a contract-based specification is logically impossible for the one or more selections. Alternatively, in some embodiments, the formal proof can determine a counter-example that violates the contract-based specification. In some embodiments, the verification checker can be a k-induction based model checker.

The method 200 can proceed to decision block 210, where it is determined if changes are desired. For example, if the formal proof indicates a counter-example that violates the contract-based specification, a design of the system can be revised to address the security risk, and the architectural model may be revised accordingly by returning to process block 204 via iteration line 214. Alternatively, or additionally, in some embodiments, it may be desirable to assess the system with respect to a different threat scenario (e.g., using different threat actors), in which case the method 200 may proceed to process block 206 via iteration line 212, for example, to annotate the architectural model with different selections from the security verification library. Otherwise, if no further iterations are desired at decision block 210, the method 200 may terminate at terminator 216.

Although blocks 202-216 of FIG. 2A have been described as being performed once, in some embodiments, multiple repetitions of a particular block may be employed before proceeding to the next decision block or process block. In addition, although blocks 202-216 of method 200 have been separately illustrated and described, in some embodiments, process blocks may be combined and performed together (simultaneously or sequentially). Moreover, although FIG. 2A illustrates a particular order for blocks 202-216, embodiments of the disclosed subject matter are not limited thereto. Indeed, in certain embodiments, the blocks may occur in a different order than illustrated or simultaneously with other blocks. In some embodiments, method 200 can include steps or other aspects not specifically illustrated in FIG. 2A. Alternatively or additionally, in some embodiments, method 200 may comprise only some of blocks 200-216 of FIG. 2A.

Referring to FIG. 2B, aspects of another method 220 for assessing security of a system are shown. In some embodiments, method 220 may be a model-based security assessment (MBSA) formalized to help systems and security engineers with early detection of, and protection from, design and implementation related weaknesses and vulnerabilities that may lend a system to potential failures and cyber-attacks. In some embodiments, performance of method 220 (or aspects thereof) can be separated into three separate roles to conduct the assessment as a game, for example, White Cell team, Red Cell team, and Blue Cell team. In some embodiments, the analysis provided by method 220 can provide a Red Team-tabletop exercise on a pre-built system that may be updated throughout its development life cycle as the risks are better understood and the architecture is more fully developed.

In some embodiments, members of the White Cell can include systems and security engineers, observers, and data correlators for the MBSA engagement. In some embodiments, the White Cell can be tasked with designing the architectural model to specify the operational environment of the system. Alternatively, or additionally, in some embodiments, the White Cell may also select or construct packages (e.g., selections for or from the security verification library) for the Red and Blue Cells to utilize in adding selections to the architectural model and in stepping through their respective offensive and defensive strategies. Since members of the White Cell may understand the system and its requirements better than other teams, they may use this information to analyze actions of the Red and Blue Cells in evaluating the MBSA and to determine if additional security requirements are needed within the system design. In some embodiments, the White Cell may assist the Red Cell and/or the Blue Cell with modeling their respective strategies.

In some embodiments, members of the Red Cell can conduct the offensive portion of the MBSA, for example, including actions, strategies, and plans. In some embodiments, the Red Cell can research potential system components and operational environments that may be included within the MBSA scope, for example, to develop and model offensive tactics, techniques, and procedures that may occur within the system using selections from the security verification library. Alternatively, or additionally, in some embodiments, member of the Blue Cell may be defensive operators within the MBSA. For example, the Blue Cell can have responsibilities similar to those of the Red Cell, but on the defensive side. In some embodiments, the Blue Cell can research potential system components and operational environments to determine how best to monitor and/or respond to, or prevent, Red Cell activities.

The method 220 can initiate at process block 222, where a library of data structures can be provided. In some embodiments, the library of data structures can be developed as named constants based in the security verification library. For example, the data structures can represent concrete security threat actors, vulnerabilities or weaknesses, and techniques. The method 220 can proceed to process block 224, where a system data flow diagram can be created based on system requirements. For example, the created diagram can depict the known software and/or hardware in the system architecture. In some embodiments, the diagram can be created as an architectural model using AADL tooling.

In some embodiments, the creation of process block 224 can be performed, at least in part, by the White Cell. For example, the White Cell may identify the security requirements, standards, controls, and models utilized in-house for risk management, and these structures may be converted into a package library of Refined AGREE Named Constant objects for the organization's use in modeling risks. In some embodiments, this may occur at the organizational level to ensure that the same syntax is used to describe different system models. Alternatively, or additionally, in some embodiments, system engineers from the White Cell may apply SDLC processes in developing the intended system following the organization's system development methodology, such as the system engineering V-model, the waterfall model, iterative enhancement, and Agile methods. These processes may include the various life cycle stages that may include requirement gathering, design, development, integration, verification and validation. Security design may be verified and validated for requirements, such as attacks that have to be overcome, or vulnerabilities or weaknesses that the design is to avoid during this process.

The method 220 may proceed to process block 226, where one or more risk scenarios can be identified, and the model can be annotated with one or more selections from the security verification library. For example, threat actors and/or defensive players, along with their respective capabilities, can be introduced into the model. In some embodiments, system engineers from the White Cell may identify, create, and/or update process flow information within the notional system design as part of process block 226. Alternatively, or additionally, security engineers from the White Cell may identify and/or manage related risk scenarios.

The method 220 may proceed to process block 228, where the verification checker can validate the conciseness of the model, for example, based on updates to the architectural model and definition of one or more behavior specifications. In some embodiments, as part of process block 228, system engineers of the White Cell may capture information in a shared model, for example, including high-level hardware and software architecture, nominal behaviors at the component level, and security requirements and risk scenarios at the system level. Alternatively, or additionally, the White Cell may use the verification checker (e.g., a back-end model checkers used by AADL) to verify that security requirements are satisfied by the model, for example, prior to introduction of any threat actors and/or defensive measures.

The method 220 can proceed to decision block 230, where it is determined if the system (or architectural model thereof) should include additional components. In some embodiments, if engineers from the White Cell determine that additional components are needed, the method 220 can return to process block 224 via decision block 230, for example, to capture those additional requirements in the system design. Otherwise, the method 220 can proceed to process block 232, where the architectural model can be annotated, for example, to include attack paths based on selections from the security verification library. In some embodiments, the annotating of process block 232 may be performed by members of the Red Team (e.g., offensive security experts) and may include adding security properties to components and their communication channels, as well as corresponding exploitation techniques to a threat actor, for example, to generate attack paths that achieve risk scenario objectives. The method 220 can proceed to process block 234, where behavioral results of the annotated model can be analyzed, for example, by using a verification checker to evaluate the architectural model and validate results. For example, the Red Cell may use the verification checker to verify that security requirements are satisfied by the model.

The method 220 can proceed to decision block 236, where it is determined if a weakness has been identified. For example, if the analysis of process block 234 reveals that the security requirements are not satisfied, design changes can be made by returning to process block 224 via decision block 236. For example, the Red Cell may communicate any potential component weakness that may impact system design to the White Cell, who may in turn revisit to identify new requirements for components and/or redesign the system. Otherwise, the method 220 can proceed to process block 238, where the architectural model can be further annotated, for example, to include defensive techniques based on selections from the security verification library. In some embodiments, the annotating of process block 238 may be performed by members of the Blue Cell (e.g., defensive security experts) and may include adding defensive techniques given the presence of weaknesses, vulnerabilities, and the threat actor, for example, to generate defensive paths that may prevent, monitor, and/or respond to the actions of the Red Cell. The method 220 can proceed to process block 240, where behavioral results of the further annotated model can be analyzed, for example, by using the verification checker to further evaluate the architectural model and validate results. For example, the Blue Cell may use the verification checker to verify that security requirements are satisfied by the model, even while the Red Cell may be active.

The method 220 can proceed to decision block 242, where it is determined if additional controls are desirable. For example, if the analysis of process block 240 suggest potential security controls that may require changes to the design, the design changes can be made by returning to process block 224 via decision block 242. For example, the Blue Cell may communicate such changes to the White Cell, who may in turn revisit to identify new requirements for components and/or redesign the system. Alternatively, or additionally, in some embodiments, it may be desirable to iterate through method 220 several times, for example, to work through actions and/or responses from either the system and/or the opposing player. Otherwise, the method 220 can proceed from decision block 242 to terminator 244.

Although blocks 222-244 of method 220 have been described as being performed once, in some embodiments, multiple repetitions of a particular block may be employed before proceeding to the next decision block or process block. In addition, although blocks 222-244 of method 220 have been separately illustrated and described, in some embodiments, process blocks may be combined and performed together (simultaneously or sequentially). Moreover, although FIG. 2B illustrate a particular order for blocks 222-244, embodiments of the disclosed subject matter are not limited thereto. Indeed, in certain embodiments, the blocks may occur in a different order than illustrated or simultaneously with other blocks. In some embodiments, method 220 can include steps or other aspects not specifically illustrated in FIG. 2B. Alternatively or additionally, in some embodiments, method 220 may comprise only some of blocks 222-244 of FIG. 2B.

### Computer Implementation Examples

FIG. 2C depicts a generalized example of a suitable computing environment 231 in which the described innovations may be implemented, such as but not limited to aspects of security assessment system 100 (or one or more components thereof), security assessment method 200, security assessment method 220, architectural model 300, and/or architectural model 320. The computing environment 231 is not intended to suggest any limitation as to scope of use or functionality, as the innovations may be implemented in diverse general-purpose or special-purpose computing systems. For example, the computing environment 231 can be any of a variety of computing devices (e.g., desktop computer, laptop computer, server computer, tablet computer, etc.).

With reference to FIG. 2C, the computing environment 231 includes one or more processing units 235, 237 and memory 239, 241. In FIG. 2C, this basic configuration 251 is included within a dashed line. The processing units 235, 237 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 2C shows a central processing unit 235 as well as a graphics processing unit or co-processing unit 237. The tangible memory 239, 241 may be volatile memory (e.g., registers, cache, RAM), non-volatile memory (e.g., ROM, EEPROM, flash memory, etc.), or some combination of the two, accessible by the processing unit(s). The memory 239, 241 stores software 233 implementing one or more innovations described herein, in the form of computer-executable instructions suitable for execution by the processing unit(s).

A computing system may have additional features. For example, the computing environment 231 includes storage 261, one or more input devices 271, one or more output devices 281, and one or more communication connections 291. An interconnection mechanism (not shown) such as a bus, controller, or network interconnects the components of the computing environment 231. Typically, operating system software (not shown) provides an operating environment for other software executing in the computing environment 231, and coordinates activities of the components of the computing environment 231.

The tangible storage 261 may be removable or non-removable, and includes magnetic disks, magnetic tapes or cassettes, CD-ROMs, DVDs, or any other medium which can be used to store information in a non-transitory way, and which can be accessed within the computing environment 231. The storage 261 can store instructions for the software 233 implementing one or more innovations described herein.

The input device(s) 271 may be a touch input device such as a keyboard, mouse, pen, or trackball, a voice input device, a scanning device, or another device that provides input to the computing environment 231. The output device(s) 281 may be a display, printer, speaker, CD-writer, or another device that provides output from computing environment 231.

The communication connection(s) 291 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Security Assessment Examples

### Attack-Defense Data Structure Examples

In some embodiments, the disclosed security verification library may be referred to as a Compositional Attack-Defense Annex (CADA). For example, CADA may use data structures of AGREE record objects that are similar to C structs and listed as sub-dimensional properties of entities described. They may represent the attacker and defender players within the model, prerequisite and post-outcome reward information related to their moves, and security-relevant information that may be attached to AADL components. For example, there may be eleven AGREE records in total provided by CADA to model offensive and defensive operations of the attacker, of the defender, and of components. The following records, R1-R8, may be the base data structures used to describe an attacker's state and information related to conducting actions within the refined system model:
R1 ATTACKER: This 15-ary predicate may represent the state of the top-level attacker's knowledge, resource, and psychology sub-dimensional properties as they perform actions relevant to meeting some objective:
   attacker(attId: ID, xₒₖ:OFF_K, xₚₒₖ:PHYS_OFF_K,
      xₙₒₖ:NET_OFF_K, xₛₒₖ:SW_OFF_K, x_{dr}:DIST_R,
      xₘᵣ: MNPWR_R, xₜᵣ:TOOLS_R, x_{fr}:FNCE_R,
      xₐₚ:AIM_P, xₚₐₚ:PHYS_AIM_P, xᵥₐₚ:VIRT_AIM_P,
      xₕₚ:HNSTY_P, x_{cp}:CAMO_P, xₛₚ:STRAT_P)
         where attId represents identification, xₒₖ represents offensive knowledge, xₚₒₖ represents physical offensive knowledge, xₙₒₖ represents network offensive knowledge, xₛₒₖ represents software offensive knowledge, x_{dr} represents distance resource, xₘᵣ represents manpower resource, xₜᵣ represents tools resource, x_{fr} represents financial resource, xₐₚ represents aim psychology, xₚₐₚ represents physical aim psychology, xᵥₐₚ represents virtual aim psychology, xₕₚ represents honesty psychology, x_{cp} represents camouflage psychology, and xₛₚ represents strategy psychology. For example, the R1 data structure can detail the capabilities and objectives of some attacker (which may include one or more people), which may depend on their knowledge (e.g., overall offensive knowledge, physical attack knowledge, network attack knowledge, software attack knowledge, etc.), resources (e.g., distance from the system, manpower, tools, finances, etc.), and psychology (e.g., aim of the attack, physical attack aim, virtual attack aim, honesty, ability to camouflage their actions, strategy, etc.).
R2 ATTACKER_COMPONENT: This 7-ary predicate may represent the state of the attacker's sub-dimensional properties relative (or localized) to some specific component as they perform actions relevant to meeting some objective:
   attacker_comp (attId:ID, CompID:ID, persistence:BOOL,
      x_{ck}: COMP_K, xₚₖ: PROT_K, x_{sck}: SRC_CODE_K,
      x_{crk}: CREDS_K).
         While R1 measured the attackers' capabilities and objectives at the overall system level, the model in R2 may provide a unique measurement for different capabilities and objectives at the subcomponent level. The persistence Boolean may recognize whether or not the subcomponent is under the attacker's control. Moreover, while it may be presumed that resources and psychology are global characteristics, an attacker's knowledge of a subcomponent may assist with their TTPs, for example, subcomponent knowledge, communication protocol knowledge, source code knowledge, identified credentials for the subcomponent, etc. In some embodiments, standards or frameworks can be mapped to R1 (or component R2), for example, to provide values that become constants used to instantiate R1 (or R2). For example, R1 and/or R2 may be taken from exemplary threat models, such as but not limited to, nation state, cybercriminal, terrorist, hacktivist, insider, basic user, or hobbyist.
R3 A_PRE_TECHNIQUE: This 16-ary predicate may represent the prerequisite sub-dimensional properties needed to perform some offensive action:
   a_pre_tech (actId: ID, preActID: ID, triggered: BOOL, exposed: BOOL,
   xₒₖ: OFF_K, xₚₒₖ: PHYS_OFF_K, xₙₒₖ: NET_OFF_K,
   xₛₒₖ: SW_OFF_K, x_{ck}: COMP_K, xₚₖ: PROT_K,
   x_{sck}: SRC_CODE_K, x_{crk}: CREDS_K, x_{dr}: DIST_R,
   xₘᵣ: MNPWR_R, xₜᵣ: TOOLS_R, x_{fr}: FNCE_R).

For example, R3 may provide the prerequisite details that some attacker would need to meet in order to proceed with some attack step. This information may include, but is not limited to, knowledge, resources, and psychology models that were described in the attacker model, as well as Boolean values that define whether some prior action within the system (which may or may not have been conducted by the attacker) triggered or exposed the attacker's accessibility of the technique.
R4 A_POST_TECHNIQUE: This 16-ary predicate may represent the post-outcome sub-dimensional properties used to update the attacker and attacker comp objects when an action is performed:
   a_pos_tech (actId: ID, postActID: ID, persistence: BOOL, xₒₖ: OFF_K,
      xₚₒₖ: PHYS_OFF_K, xₙₒₖ: NET_OFF_K, xₛₒₖ: SW_OFF_K,
      x_{ck}: COMP_K, xₚₖ: PROT_K, x_{sck}: SRC_CODE_K,
      x_{crk}: CREDS_K, x_{dr}: DIST_R, xₘᵣ: MNPWR_R,
      xₜᵣ: TOOLS_R, x_{fr}: FNCE_R).
         For example, R4 may provide the post-outcome details that some attacker may achieve with the completion of some attack step. This information may include, but is not limited to, knowledge and resources models that were described in the attacker model. Alternatively, or additionally, R4 may allow the attacker with persistent access to some subcomponent. In some embodiments, standards or frameworks can be mapped to R3 (or R4), for example, to provide values that become constants used to instantiate R3 (or R4). For example, R3 and/or R4 may be taken from MITRE ATT&CK® and/or MITRE CAPEC™.
R5 DEFENDER: This 14-ary predicate may represent the state of the top-level defender's knowledge, resource, and psychology sub-dimensional properties as they may perform actions relevant to defending the system:
   defender (defId: ID, x_{dk}: DEF_K, x_{pdk}: PHYS_DEF_K,
      x_{ndk}: NET_DEF_K, x_{sdk}: SW_DEF_K, x_{dr}: DIST_R,
      xₘᵣ: MNPWR_R, xₜᵣ: TOOLS_R, x_{fr}: FNCE_R,
      xₐₚ: AIM_P, xₚₐₚ: PHYS_AIM_P, xᵥₐₚ: VIRT_AIM_P,
      x_{cp}: CAMO_P, xₛₚ: STRAT_P).
         For example, R5 may detail the capabilities and objectives of some defender (which may include one or more people), which may depend on their knowledge (e.g., overall defensive knowledge, physical defense knowledge, network defense knowledge, software defense knowledge, etc.), resources (e.g., distance from the system, manpower, tools, finances, etc.), and psychology (e.g., aim of the defender, physical defense aim, virtual defense aim, ability to camouflage their actions, strategy, etc.).
R6 DEFENDER_COMPONENT: This 8-ary predicate may represent the state of the defender's sub-dimensional properties relative to some specific component as they perform actions relevant to meeting some objective:
   defender_comp (defId: ID, defCompID: ID, monitoring: BOOL,
      responding: BOOL, x_{ck}: COMP_K, xₚₖ: PROT_K,
      x_{sck}: SRC_CODE_K, x_{crk}: CREDS_K).
         While R5 measured the defenders' capabilities and objectives at the overall system level, the model in R6 may provide a unique measurement for different capabilities and objectives at the subcomponent level. The monitoring Boolean may recognize whether or not the subcomponent is under the defender's watchful eye. The responding Boolean may recognize whether or not the defender is responding or conducting some activity within the subcomponent. Moreover, while it may be presumed that resources and psychology are global characteristics, a defender's knowledge of a subcomponent may assist with their TTPs, for example, subcomponent knowledge, communication protocol knowledge, source code knowledge, identified credentials for the subcomponent, etc. In some embodiments, standards or frameworks can be mapped to R5 (or component R6), for example, to provide values that become constants used to instantiate R5 (or R6). For example, R5 and/or R6 may be taken from exemplary defense models, such as but not limited to, incidence responder, operator, or security engineer.
R7 D_PRE_TECHNIQUE: This 17-ary predicate may represent the prerequisite sub-dimensional properties needed to perform some defensive action:
   d_pre_tech (dactId: ID, preDactID: ID, monitor: BOOL,
      respond: BOOL, control: BOOL, x_{dk}: DEF_K,
      x_{pdk}: PHYS_DEF_K, x_{ndk}: NET_DEF_K, x_{sdk}: SW_DEF_K,
      x_{ck}: COMP_K, xₚₖ: PROT_K, x_{sck}: SRC_CODE_K,
      x_{crk}: CREDS_K, x_{dr}: DIST_R, xₘᵣ: MNPWR_R,
      xₜᵣ: TOOLS_R, x_{fr}: FNCE_R).
         For example, R7 may provide the prerequisite details that some defender would need to meet in order to proceed with some defense step. This information may include, but is not limited to, knowledge, resources, and psychology models that were described in the defender model, as well as Boolean values whether some prior action within the system (which may or may not have been conducted by the defender) requires the defender to be monitoring or responding to enable the accessibility of the technique.
R8 D_POST_TECHNIQUE: This 16-ary predicate may represent the post-outcome sub-dimensional properties used to update the defender and defender comp objects when the action is performed:
   d_pos_tech (dactId: ID, postDactID: ID, monitoring: BOOL,
      responding: BOOL, x_{dk}: DEF_K, x_{pdk}: PHYS_DEF_K,
      x_{ndk}: NET_DEF_K, x_{sdk}: SW_DEF_K, x_{ck}: COMP_K,
      xₚₖ: PROT_K, x_{sck}: SRC_CODE_K, x_{crk}: CREDS_K,
      x_{dr}: DIST_R, xₘᵣ: MNPWR_R, xₜᵣ: TOOLS_R,
      x_{fr}: FNCE_R).
         For example, R8 may provide the post-outcome details that some defender would achieve with the completion of some defensive step. This information may include, but is not limited to, knowledge and resources models that were described in the defender model. Alternatively, or additionally, R8 may allow the defender to begin or continue monitoring/responding within some subcomponent. In some embodiments, standards or frameworks can be mapped to R7 (or R8), for example, to provide values that become constants used to instantiate R7 (or R8). For example, R7 and/or R8 may be taken from MITRE D3FEND™.

To model attacking and defensive operations within a system, the sub-components found within a system may have information that can be utilized by the attacker or defender. In some embodiments, the following records, R9-R11, may be the base data structures used to describe this security-relevant information within the system model:
R9. SECURITY CONTROL: This 6-ary predicate may represent some security control that may or may not be enabled within a component:
   sec_control (sysId: System, ctrID: ID, enabled: BOOL,
      bypassed: BOOL, updated: BOOL, cost: INT).
         For example, the presence of some security control within a subcomponent may or may not prohibit some attack event from occurring. In some embodiments, there may be several values that determine whether or not the security control may be used, for example, to include whether it is enabled, whether the attacker bypassed the control, whether the defender has updated (or modified) the control in some way to make it effective, or even the cost of the control. In some embodiments, standards or frameworks can be mapped to R9, for example, to provide values that become constants used to instantiate R9. For example, R9 may be taken from National Institute of Standards and Technology (NIST) SP 800-53, Rev. 5.
R10 WEAKNESS: This 5-ary predicate may represent some inherent component weakness or vulnerability and includes relevant a_pre_tech and a_post_tech data structures that respectively represent requirements to exploit the weakness or exploitation outcomes:
   weakness (sysId: System, wkID: ID, enabled: BOOL,
      pre: A_PRE_TECH, post: A_POST_TECH).
         For example, the presence of some weakness within a subcomponent may provide opportunity for some attack event to occur. In some embodiments, the model may have prerequisite steps in order to conduct some attack (A_PRE_TECH), as well as post outcome, for example, knowledge and/or recourse information that an attacker may gain. In some embodiments, standards or frameworks can be mapped to R10, for example, to provide values that become constants used to instantiate R10. For example, R10 may be taken from MITRE CVE or MITRE CWE.
R11. ARTIFACT: This 4-ary predicate may represent interesting data (e.g., events, credentials, etc.) to either attackers or defenders that may be used to update the player's state and strategies based on the information that they represent:
   artifact(sysId: System, artID: ID, enabled: BOOL,
      generated: BOOL).
         For example, the presence of some artifact within a subcomponent may provide opportunity for some attack or defense event to occur. In some embodiments, an artifact may vary in its form, (e.g., passwords, log entries, configuration details, etc.), and the Boolean values within this model may allow the artifact to be either enabled or generated, which then may be used to trigger some attack or defense action if other conditions are met. In some embodiments, standards or frameworks can be mapped to R11, for example, to provide values that become constants used to instantiate R11. For example, R11 may be taken from MITRE D3FEND™ or Digital Artifact Ontology.

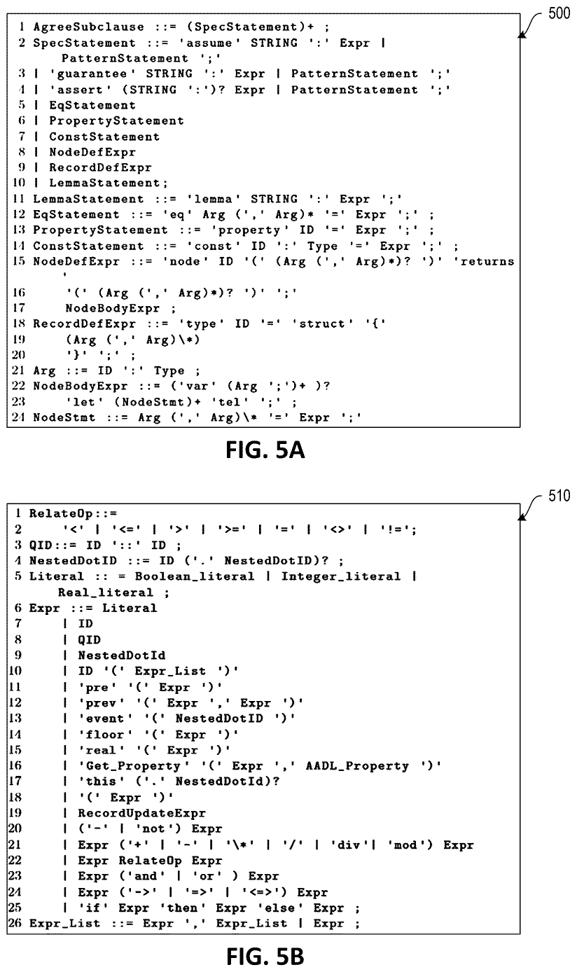

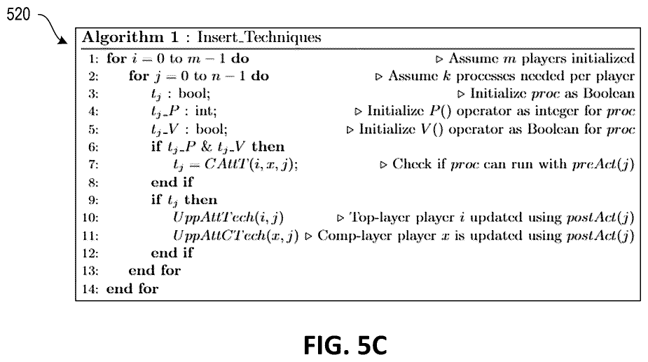

In some embodiments, records R1-R11, as described above, may be used to develop libraries in top-layer packages, for example, through the use of AGREE named records that map to actual standards and frameworks. For example, these AGREE named records may be declared as structs by combining the ConstStatement (e.g., line 14 in Listing 500 of FIG. 5A) and RecordDefExpr (e.g., lines 18-20 in Listing 500 of FIG. 5A) subclauses.

In some embodiments, by inheriting properties of record objects R1-R11, an organization may create a library of initialized data structures related to the standards and frameworks required for their risk management needs. For example, when an annotated architectural model is executed by the verification checker, constant values assigned to the records may be used to instantiate the starting states for the ATTACKER, ATTACKER_COMPONENT, DEFENDER, and DEFENDER_COMPONENT objects and these values may be updated as each entity utilizes techniques to achieve their objectives. In some embodiments, these data structures may be derived predicates in the formulation, and may include AGREE named constants where the sub-dimensional properties provide explicit values for use in initializing the model:

R12. Check_Attack_Technique: This CADA node may run a check to determine if the combined ATTACKER and ATTACKER COMPONENT object properties meet the prerequisites from an A_PRE_TECH object to run some technique. If the function Check Attack Technique is found to be true within the AGREE model checker, then this may imply that the attacker has the capability to run this technique during this time slot:

$$CAttT ( a : ATTACKER , a c : ATTACKER\_COMP , apt : A\_PRE \_TECH ) :$$

$$apt . triggered ∨ apt . exposed ∨ ( ( a . {x}_{o k} \geq apt . {x}_{o k} ) ∧ ( a . {x}_{p o k} \geq apt . {x}_{p o k} ) ∧ ( a . {x}_{n o k} \geq apt . {x}_{n o k} ) ∧ ( a . {x}_{s o k} \geq apt . {x}_{s o k} ) ∧ ( a c . {x}_{c k} \geq apt . {x}_{c k} ) ∧ ( a c . {x}_{p k} \geq apt . {x}_{p k} ) ∧ ( a c . {x}_{s c k} \geq apt . {x}_{s c k} ) ∧ ( a c . {x}_{c r k} \geq apt . {x}_{c r k} ) ∧ ( a . {x}_{dr} ∈ apt . {x}_{dr} ) ∧ ( a . {x}_{m r} ∈ apt . {x}_{m r} ) ∧ ( a . {x}_{tr} ∈ apt . {x}_{tr} ) ∧ ( a . {x}_{f r} \geq apt . {x}_{f r} ) ) .$$

For example, the R12 function can take the attacker model at the system level and at the subcomponent level, and can check the complete attacker model against the knowledge, resource, and psychology information required by the pre-requisite check for some action.

R13. Update_Attacker_From_Technique: This CADA node may return an ATTACKER object updated by the contents of an A POST TECH object, symbolizing offensive gains after some technique has run completely:

$$UpAttTech ( a : ATTACKER , apt : \\ A\_POST \_TECH ) \to ATTACKER ( attID = a . attID ,$$

$${x}_{ok} = ( a . {x}_{ok} < apt , {x}_{ok} ? apt . {x}_{ok} : a . {x}_{ok} ) ,$$

$${x}_{pok} = ( a . {x}_{pok} < apt . {x}_{pok} ? apt . {x}_{pok} : a . {x}_{pok} ) ,$$

$${x}_{nok} = ( a . {x}_{nok} < apt . {x}_{nok} ? apt . {x}_{nok} : a . {x}_{nok} ) ,$$

$${x}_{sok} = ( a . {x}_{sok} < apt . {x}_{sok} ? apt . {x}_{sok} : a . {x}_{sok} ) ,$$

$${x}_{dr} = a . {x}_{dr} , {x}_{mr} = a . {x}_{mr} , {x}_{tr} = a . {x}_{tr} ⋃ apt . {x}_{tr} ,$$

$${x}_{fr} = a . {x}_{fr} - apt . {x}_{fr} , {x}_{ap} = a . {x}_{ap} , {x}_{pap} = a . {x}_{pap} ,$$

$${x}_{vap} = a . {x}_{vap} , {x}_{h p} = a . {x}_{h p} , {x}_{cp} = a . {x}_{cp} , {x}_{sp} = a . {x}_{sp} ) .$$

For example, the R13 function can update the attacker model at the system level with the received knowledge and resource post-outcome information due to some event they completed.

R14. Update_Attacker_Component_From_Technique: This CADA node may return an ATTACKER_COMPONENT object updated by the contents of an A_POST_TECH object, symbolizing the attacker gained some localized information to a component after some technique has run completely:

$$UpAttCTech ( a c : ATTACKER\_COMP , apt : \\ A\_POST \_TECH ) \to ATTACKER\_COMP ( attID = a c . attID ,$$

$$CompID = a c . CompID ,$$

$$persistence = ( apt . persistence ? true : a c . persistence ) ,$$

$${x}_{ck} = ( a c . {x}_{ck} < apt . {x}_{ck} ? apt . {x}_{ck} : a c . {x}_{ck} ) ,$$

$${x}_{p k} = ( a c . {x}_{p k} < apt . {x}_{p k} ? apt . {x}_{p k} : a c . {x}_{p k} ) ,$$

$${x}_{sck} = ( a c . {x}_{sck} < apt . {x}_{sck} ? apt . {x}_{sck} : a c . {x}_{sck} ) ,$$

$${x}_{crk} = ( a c . {x}_{crk} < apt . {x}_{crk} ? apt . {x}_{crk} : a c . {x}_{crk} ) ) .$$

For example, the R14 function can update the attacker model at the subcomponent level with the received knowledge post-outcome information due to some event they completed.

R15. Check_Defend_Technique: This CADA node may determine if the combined properties from the DEFENDER and DEFENDER_COMPONENT objects meet the prerequisites from a D_PRE_TECH object to run some technique:

$$CDefT ( d : DEFENDER , d c : DEFENDER\_COMP , dpt : D\_PRE \_TECH ) :$$

$$( ( d c . monitoring = dpt . monitor ) ∨ ( d c . responding = dpt . respond ) ∨ ( dpt . control ) ) ∧ ( ( d . {x}_{dk} \geq dpt . {x}_{dk} ) ∧ ( d . {x}_{pdk} \geq dpt . {x}_{pdk} ) ∧ ( d . {x}_{ndk} \geq dpt . {x}_{ndk} ) ∧ ( d . {x}_{sdk} \geq dpt . {x}_{sdk} ) ∧ ( d c . {x}_{c k} \geq dpt . {x}_{c k} ) ∧ ( d c . {x}_{p k} \geq dpt . {x}_{p k} ) ∧ ( d c . {x}_{s c k} \geq dpt . {x}_{s c k} ) ∧ ( d c . {x}_{c r k} \geq dpt . {x}_{c r k} ) ∧ ( d . {x}_{dr} ∈ dpt . {x}_{dr} ) ∧ ( d . {x}_{m r} ∈ dpt . {x}_{m r} ) ∧ ( d . {x}_{tr} ∈ dpt . {x}_{tr} ) ∧ ( d . {x}_{f r} \geq dpt . {x}_{f r} ) ) .$$

For example, the R15 function can take the defender model at the system level and at the subcomponent level, and checks the complete defender model against the knowledge, resource, and psychology information required by the pre-requisite check for some action.

R16. Update_Defender_From_Technique: This CADA node may return a DEFENDER object updated by the contents of a D_POST_TECH object, symbolizing defensive gains after some technique may have run completely:

$$UpDefTech ( d : DEFENDER , dpt : \\ D\_POST \_TECH ) \to DEFENDER ( defID = d . defID ,$$

$${x}_{dk} = ( d . {x}_{dk} < dpt . {x}_{dk} ? dpt . {x}_{dk} : d . {x}_{dk} ) ,$$

$${x}_{pdk} = ( d . {x}_{pdk} < dpt . {x}_{pdk} ? dpt . {x}_{pdk} : d . {x}_{pdk} ) ,$$

$${x}_{ndk} = ( d . {x}_{ndk} < dpt . {x}_{ndk} ? dpt . {x}_{ndk} : d . {x}_{ndk} ) ,$$

$${x}_{sdk} = ( d . {x}_{sdk} < dpt . {x}_{sdk} ? dpt . {x}_{sdk} : d . {x}_{sdk} ) ,$$

$${x}_{dr} = d . {x}_{dr} , {x}_{mr} = d . {x}_{mr} , {x}_{tr} = d . {x}_{tr} ⋃ dpt . {x}_{tr} ,$$

$${x}_{fr} = d . {x}_{fr} - dpt . {x}_{fr} , {x}_{ap} = d . {x}_{ap} , {x}_{pap} = d . {x}_{pap} ,$$

$${x}_{vap} = d . {x}_{vap} , {x}_{cp} = d . {x}_{cp} , {x}_{sp} = d . {x}_{sp} ) .$$

For example, the R16 function can update the defender model at the system level with the received knowledge and resource post-outcome information due to some event they completed.

R17. Update_Defender_Component_From_Technique: This CADA node may return a DEFENDER_COMPONENT object updated by the contents of a D_POST_TECH object, symbolizing the defender gained some localized information to a component after some technique has run completely:

$$UpDefCTech ( d c : DEFENDER\_COMP , dpt : \\ D\_POST \_TECH ) \to DEFENDER\_COMP ( defID = d c . defID ,$$

$$defCompID = d c . defCompID ,$$

$$monitoring = ( dpt . monitoring ? true : d c . monitoring ) ,$$

$$responding = ( dpt . responding ? true : d c . responding ) ,$$

$${x}_{ck} = ( d c . {x}_{ck} < dpt . {x}_{ck} ? dpt . {x}_{ck} : d c . {x}_{ck} ) ,$$

$${x}_{pk} = ( d c . {x}_{p k} < dpt . {x}_{p k} ? dpt . {x}_{p k} : d c . {x}_{p k} ) ,$$

$${x}_{sck} = ( d c . {x}_{sck} < dpt . {x}_{sck} ? dpt . {x}_{sck} : d c . {x}_{sck} ) ,$$

$${x}_{crk} = ( d c . {x}_{crk} < dpt . {x}_{crk} ? dpt . {x}_{crk} : d c . {x}_{crk} ) ) .$$

For example, the R17 function can update the defender model at the subcomponent level with the received knowledge post-outcome information due to some event they completed. In some embodiments, logical ordering of actions may adhere to AGREE syntax to ensure that the model checker provides a correct counterexample for analyzing behaviors within the system of the attacker or defender. For example, sequential actions may employ a semaphore to ensure atomic execution of sequenced actions. In some embodiments, conjunctive actions may be enclosed within a coBegin/coEnd pair, and/or disjunctive actions may be read as a non-deterministic choice between those actions.

In some embodiments, R12-R17 may serve as a set of executable logical constraints (e.g., AGREE nodes) that mathematically define the admissible state transitions for actors. These nodes do not merely simulate a specific attack sequence; rather, they serve as the transition relations utilized by the verification checker (e.g., k-induction solver) to exhaustively prove whether any valid sequence of state transitions can result in violation of the desired specification (e.g., system safety contract).

In some embodiments, the data structures and contract-based specifications may be structured according to a defined formal grammar, for example, to facilitate the parsing and execution of the security verification library by the verification checker. By way of example and not limitation, the Backus-Naur Form (BNF) Listings 500, 510 shown in FIGS. 5A-5B illustrate the grammar of the Assume-Guarantee Reasoning Environment (AGREE) language as specified in the AGREE User Guide (Loonwerks, Collins Aerospace). For example, Listing 500 of FIG. 5A shows AGREE subclauses and Listing 510 of FIG. 5B shows AGREE expressions that define the syntactical structures available within the AADL/AGREE extension environment. In some embodiments, the data structures (e.g., R1-R11) and the executable logic nodes (e.g., R12-R17) of the security verification library may be constructed using such AGREE subclauses and expressions. Those skilled in the art will recognize that alternative syntaxes, delimiters, or grammatical structures may be employed without departing from the scope of the disclosed subject matter.

In some embodiments, these subclauses may be found either within the annex agree environment declared within these components, or they may be used within a top-layer package which are standalone AADL files that may provide reusable libraries of definitions for AGREE. In some embodiments, CADA can include top-layer packages to declare the R1-R11 entities, such as attacker-, defender-, and component-associated AGREE records. Alternatively, or additionally, top-layer packages may be used to declare AGREE nodes (e.g., R12-R17), for example, through the NodeDefExpr subclause from line 15 in Listing 500 in FIG. 5A, where the function body can be provided as a NodeBodyExpr subclause from lines 22-23 in Listing 500 in FIG. 5A. In some embodiments, constants and nodes declared in packages may be referenced by component-layer subclauses by using the notation: <Package Name>::<definition name>. Alternatively, or additionally, the AGREE named records may be declared as structs by combining the Const Statement (line 14 in Listing 500) and RecordDefExpr (lines 18-20 in Listing 500) subclauses.

TABLE 2
CADA model abstractions and refinements.

| Abstraction | Refinement | Refinement Meaning |
|---|---|---|
| [A1] arithmetic ops. | Expr. 1 and 2 from listing (FIG. 5B) | AGREE mathematical expressions |
| [A2] player | [R1] ATTACKER + | Attacker at top and component layers |
| | [R2] ATTACKER_COMP | |
| | [R5] DEFENDER + | Defender at top and component layers |
| | [R6] DEFENDER_COMP | |
| [A3] preAct | [R3] A_PRE-TECHNIQUE | Pre-conditions for attack action |
| | [R7] D_PRE-TECHNIQUE | Pre-conditions for defense action |
| [A4] postAct | [R4] A_POST_TECHNIQUE | Post-outcomes of attack action |
| | [R8] D_POST_TECHNIQUE | Post-outcomes of defense action |
| [A5] compSec | [R9] SECURITY_CONTROL | Defensive security controls in component |
| | [R10] WEAKNESS | Weaknesses/vulnerabilities in component |
| | [R11] ARTIFACT | Data artifacts in component |
| [A6] CanPlay | [R12] CAttT | Check if attack preconditions met |
| | [R15] CDefT | Check if defense preconditions met |
| [A7] Play | [R13] UpAttTech + | Update attacker with action outcomes |
| | [R14] UpAttCTech | |
| | [R16] UpDefTech + | Update defender with action outcomes |
| | [R17] UpDefCTech | |
| [A10] [A11] A/G | Subcl. 2 and 3 from listing (FIG. | AGREE assume/guarantee clauses and |
| Boolean Ops. | 5A) and Expr. from listing (FIG. 5B) | all Boolean expressions |

In some embodiments, the abstractions describing the predicates, process execution, and assume/guarantee syntax have been refined through refinements [R1]-[R17], the AGREE subclauses in Listing 500 of FIG. 5A, and the AGREE expressions in Listing 510 of FIG. 5B. The mapped relationships between abstractions and refinements, as well as their meanings, are summarized in Table 2.

What may not be clear self-evident from Table 2 is how the abstract process model (e.g., [A8] and [A9]) can be refined using CADA. For example, at the top-layer of the model, objects representing the global attacker and defender objects can be defined and initialized, along with the component-layer attacker_comp and defender_comp objects for all relevant components. In some embodiments, Algorithm 1 (e.g., algorithm 520 in FIG. 5C) for Insert_Technique can then be performed to add mutually exclusive techniques to the model.

The approach of algorithm 520 (Insert_Technique algorithm) is intended to be a high-level description of steps for insert techniques using CADA and assumes the attacker and defender players, along with their component objects, are already initialized. In FIG. 5C, lines 1 and 2 may be simple loops that step through each player and add techniques, which approach assumes the techniques have not yet been created but are initialized elsewhere in an AADL package. In line 3 of FIG. 5C, a Boolean object representing the tj technique's pre-check may be initialized in the top-layer AGREE annex. In lines 4 and 5 of FIG. 5C, associated integer and Boolean objects may be initialized and tied to the other techniques within a mutual exclusion set of tⱼ. In lines 6 and 7 of FIG. 5C, the “if” statement may verify that the precheck for tⱼ may occur based on the semaphore's state, and if so, the Boolean may be set to the results of the CAttT function. In lines 9-11 of FIG. 5C, if the precheck passed, then the player's global object and respective local objects may be updated using UpAttTech and UpAttCTech.

In some embodiments, Assume and Guarantee statements may be used within AGREE, for example, to assert that information flows between components maintain safety and liveliness properties within the model, so as to ensure these properties are satisfied by the system. In some embodiments, CADA modeling may utilize the Assume and Guarantee statements to identify counterexamples through AGREE's model checker. The Assume and Guarantee abstractions (e.g., defined by [A10] and [A11]) may be refined in CADA models through the use of the AGREE subclauses found in lines 2 and 3 in Listing 500 of FIG. 5A. In some embodiments, this may occur at the layer of the AGREE model where the state of either the attacker or defender is modeled, as it may otherwise be difficult to pass these objects in AGREE syntax to lower layers.

### CNC Case Study

This case study used a computerized numerical control (CNC) router that runs LinuxCNC, where CADA is utilized to model attacks and defenses and help visualize the logic. The roles of the White Cell, Red Cell, and Blue Cells within this case study are described herein. For the case study, it was assumed that a fictitious company was looking to develop CNC machines for a small, specialized manufacturing customer base. Early in the design process before the company decides to start purchasing components for development, their stakeholders want to engage with systems security partners to understand the types of threats that may occur within a customer's environment. As CNC machines are used in subtractive manufacturing for cutting and carving material, the company management tasks their cybersecurity risk assessors with assuring the CNC product is not susceptible to attacks that may result in a loss of control over the physical cutting process, as such loss of control may result in sub-par products or an accident with potential for injury or destruction of property. This task may involve identifying security requirements that may harden the CNC product against network and physical attacks. The risk assessors decide on modeling the system with CADA to identify the events that need to be prevented and their associated security requirements.

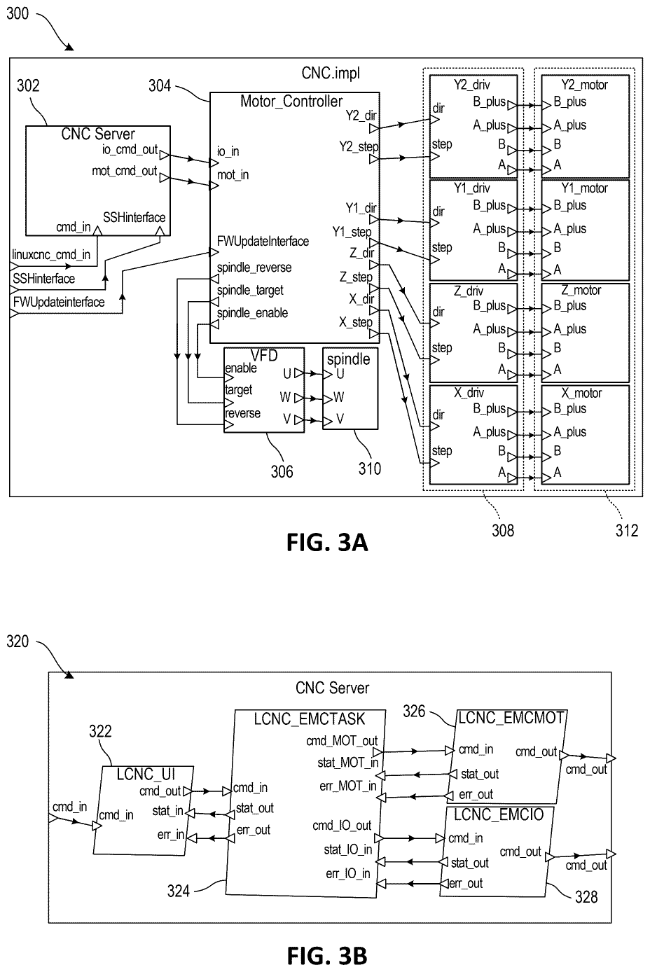

To manage this task, the risk assessors form the White, Red, and Blue Cells. The White Cell may receive a preliminary design of a control-flow diagram from their engineer. The design may include a networked server 302 running LinuxCNC software that sends instructions to a motor controller 304. The motor controller may handle the processes for physical motion through interfacing with one x-axis, two y-axis, and one z-axis motors 312 along with a motorized spindle 310 to cut the materials. With the current design, the LinuxCNC server 302 and the motor controller 304 are both accessible from an Ethernet local area network (LAN) so that customers may remotely send designs to the system. From that control-flow diagram, the White Cell may build one or more models of the LinuxCNC system using AADL within the OSATE integrated developer environment (IDE). The graphical results of this modeling exercise are shown in FIGS. 3A-3B, with model 300 in FIG. 3A reflecting the internal hardware task decomposition and data connections of the CNC system and model 320 in FIG. 3B reflecting the software processes and external network interfaces (e.g., SSHinterface) that facilitate the data connections of FIG. 3A.

The model 300 in FIG. 3A shows the hardware and logical connections of the CNC system, described as follows. The CNC Server 302 may be able to issue two commands to the motor controller 304 using LinuxCNC, motion, and I/O commands. The motor controller 304 may provide step and direction commands to each of the four motor drives 308, which in turn are wired to their respective stepper motors 312 with four wires, being A, B, A+, and B+. The motor controller 304 may provide reverse, target, and enable commands to a variable frequency drive (VFD) 306 that interfaces with the spindle 310 over three wires, which are U, V, and W.

The LinuxCNC server may have two services listening on the Ethernet network, one for LinuxCNC commands and the other for SSH-based device management. The White Cell may not yet be sure of the specifics for the yet-to-be-selected motor controller. Nevertheless, based upon a review several popular models that may meet their requirements, the White Cell may find that these devices have a network service listening for firmware updates, which are included in the model. For example, as shown in FIG. 3B, model 320 may include four LinuxCNC processes 322, 324, 326, and 328, as well as their respective data flows that run on the server. Although the company may not be running LinuxCNC within their development environment, the White Cell may have identified these processes through reviewing LinuxCNC documentation and added them to the model. These processes may be the user interface (UI) 322, task manager (EMCTASK) 324, motion controller (EMCMOT) 326, and the I/O controller (EMCIO) 328.

In this case study, the activity of modeling the target system may primarily be a White Cell responsibility. The frameworks and standards utilized by the White Cell to describe attackers, defenders, their techniques, security controls, weaknesses, and artifacts have been described above. From these frameworks and standards, the White Cell may create a library of AGREE-named constants from each of the records to utilize the library in this exercise and future modeling efforts. For example, Tables 3A-3B show some of the objects used to test the logic in the case study. Row 1 elects a CYBERCRIMINAL profile as a refined AGREE named constant for the attacker profile. This profile may have some general offensive knowledge (xₒₖ=25) with an assumption of having basic tools (xₜᵣ=basic) to perform offensive network (xₙₒₖ=25) and software (xₛₒₖ=25) attacks from the local network (x_{dr}=near). Row 2 utilizes CNC_SVR_ATTACK as the ATTACKER_COMP record associated with attacking the LinuxCNC server. As LinuxCNC is open source and readily available, no credentials are available to start (x_{crk}=none), but the White Cell provides relatively high values for the attacker's knowledge of this component, for example, a component knowledge of x_{ck}=75, a protocol knowledge of xₚₖ=25, and a source-code knowledge of x_{sck}=50.

TABLE 3A
Refined objects initialized at time = 0 for a two-step attack.

| Named Constant | Record | xₒₖ | xₚₒₖ | xₙₒₖ | xₛₒₖ | x_{ck} | xₚₖ |
|---|---|---|---|---|---|---|---|
| CYBERCRIMINAL | ATTACKER (R1) | 25 | 0 | 25 | 25 | — | — |
| CNC_SVR_ATTACK | ATTACKER_COMP (R2) | — | — | — | — | 75 | 25 |
| CAPEC565_PWD_ | A_PRE_TECHNIQUE (R3) | 25 | 0 | 0 | 0 | 25 | 25 |
| SPRAY_PRE | | | | | | | |
| CAPEC565_PWD_ | A_POST_TECHNIQUE (R4) | 0 | 0 | 0 | 0 | 0 | 0 |
| SPRAY_POST | | | | | | | |
| T0807_CL1_PRE | A_PRE_TECHNIQUE (R3) | 0 | 0 | 0 | 0 | 40 | 0 |
| T0807_CL1_POST | A_POST_TECHNIQUE (R4) | 0 | 0 | 0 | 0 | 60 | 60 |

TABLE 3B
Refined objects initialized at time = 0 for a two-step attack.

| Named Constant | x_{sck} | x_{crk} | x_{dr} | xₘᵣ | xₜᵣ | x_{fr} |
|---|---|---|---|---|---|---|
| CYBERCRIMINAL | — | — | near | low | basic | 10000 |
| CNC_SVR_ATTACK | 50 | none | — | — | — | — |
| CAPEC565_PWD_SPRAY_PRE | 0 | none | near | low | basic | 100 |
| CAPEC565_PWD_SPRAY_POST | 0 | User | near | low | basic | 100 |
| T0807_CL1_PRE | 0 | User | far | low | basic | 100 |
| T0807_CL1_POST | 60 | User | far | low | basic | 100 |

In Tables 3A-3B, Rows 3 and 4 detail the prerequisite and post-outcome values for a password spray attack from CAPEC-565 (Password Spraying). The prerequisites of this attack in row 3 involve low general offensive knowledge (xₒₖ=25), component knowledge (x_{ck}=25), and protocol knowledge (xₚₖ=25), because password spraying is a relatively simple attack and tools are readily available that target SSH (where xₜᵣ=basic). The post-outcome of this attack can be found in row 4 of Tables 3A-3B, as a successful attack may give the attacker a user credential (x_{crk}=User). Rows 5 and 6 of Tables 3A-3B describe a second technique, which can be based on the ATT&CK framework's T0807 (Command Line Interface) and simply says the attacker has command line access via the SSH service. Note that the two techniques presented here as an example are not intended to change the physical properties of the CNC server yet, but they are steps which some network attacker may take towards reaching that goal.

The refined attacker and defender actions can be defined using action predicates. For example, prerequisite and post requisite predicates of the actions can be described first, followed by the process model and the assume/guarantee refinements that describe attack-defense scenarios. For example, there may be six CADA nodes developed in AGREE that check and update the attacker and defender states at the top and component layers of the model. The first three nodes may focus on checking and updating the attacker states at the top and component layers of the model.

To process the model and assume/guarantee for the case study, the following may be performed by the Red Cell, for example, to build an attacker with two techniques whose mutual exclusion is assured through the use of a semaphore. The Red Cell may add the instructions from this process to the AGREE annex in the AADL model's top-layer system component. References to Algorithm 1 (FIG. 5C) and Listings 1 and 2 (FIGS. 5A-5B) are provided to make this information clear, with at least some aspects optionally occurring prior to Algorithm 1.

For example, an attacker structure was first initialized as CYBERATTACKER, defined within the CADA package Attacker_AGREE_Types, through subclauses from lines 12, 21 in Listing 500 of FIG. 5A and the expression from line 6 in Listing 510 of FIG. 5B:

$$eq attacker : Attack\_AGREE \_Models ∷ ATTACKER = Attacker\_AGREE \_Types ∷ CYBERATTACKER .$$

Similarly, an attacker component structure was also initialized as CNC_SVR_ATTACK, defined in package Attacker_AGREE_Types, using subclauses from lines 12 and 21 in Listing 500 of FIG. 5A and the expression from line 6 in Listing 510 of FIG. 5B:

$$eq a\_cnc \_comp : \\ Attack\_AGREE \_ATTACKER \_Models ∷ ATTACKER\_COMP = Attacker\_AGREE \_Types ∷ CNC\_SVR \_ATTACK .$$

Two Boolean values representing two mutually exclusive techniques, t1 (which is CAPEC-565, Password Spray Attack) and t2 (which is T0807, Command Line Interface), can then be declared. For now, they are initialized to false through subclauses from lines 12 and 21 in Listing 500 of FIG. 5A and the expression from lines 6 and 5 in Listing 510 of FIG. 5B. The code here may align with line 3 in Algorithm 520 of FIG. 5C:

$$eq t 1 : bool = false ;$$

$$eq t 2 : bool = false .$$

Two integers, t1_ud and t2_ud, can be declared. These integers can represent the semaphore P (set) operator for both techniques. The integers can be initialized to 0, symbolizing the technique has not yet run, and they can be incremented for each time step after the technique is permitted to run by the model. For this, subclauses from lines 12 and 21 in Listing 500 of FIG. 5A and the expressions from lines 6, 5, 18, 24, 25, 7, and 11 in Listing 510 of FIG. 5B may be used. The code here may align with line 4 in Algorithm 520 of FIG. 5C:

```
eq t1_ud : int = (0 ->
  if t1 then pre(t1_ud) + 1 else 0);
eq t2_ud : int = (0 ->
  if t2 then pre(t2_ud) + 1 else 0); .
```

Two Boolean values representing the semaphore V operator for both techniques, t1 and t2, can be declared. The Boolean values can be initialized to true. Each one may be set to false if the other technique is in the process of being executed (e.g., when its P integer is 1, in this case). For this, the subclauses from lines 12 and 21 in Listing 500 of FIG. 5A and the expressions from lines 25, 18, 7, 6, and 5 in Listing 510 of FIG. 5B may be used. The code here may align with line 5 in Algorithm 520 of FIG. 5C:

```
eq t1_ud_sp : bool =
  if (t2_ud=1) then false else true;
eq t2_ud_sp : bool =
  if (t1_ud=1) then false else true; .
```

When semaphores are defined, the t1 and t2 Boolean values may be updated to run a Boolean check, for example, to see if the attacker may run the respective technique check node, CAttT from package CADA_Nodes, and/or to verify if the attacker has the capabilities to meet the requirements from the respective CAPEC565_PRE or T0807_PRE techniques, defined in package A_Tech_AGREE_Types. This update may use the expressions from lines 24, 25, 18, 11, 7, 6, 5, and 3 in Listing 510 of FIG. 5B. The code here may align with lines 6 and 7 in Algorithm 520 of FIG. 5C:

```
eq t1 : bool = false ->
  if (pre(t1) = true) then true
  else if (t1_ud_sp) then
    CADA_Nodes : : CAttT(attacker, a_cnc_comp,
      A_Tech_AGREE_Types : : CAPEC565_PRE)
  else pre(t1);
eq t2 : bool = false ->
  if (pre(t2) = true) then true
  else if (t2_ud_sp) then
    CADA_Nodes : : CattT(attacker, a_cnc_comp,
      A_Tech_AGREE_Types : : T0807_PRE)
  else pre(t2); .
```

With the prerequisite checks and their respective semaphores defined, the attacker and attacker_comp values may be updated to include the post-outcome information from each t1 and t2 technique within the time slot the critical section has ended. The post-outcome information for each technique may come from the respective CAPEC565_POST or T0807_POST objects defined in package A_Tech_AGREE_Types. The UpAttTech node from package CADA_Nodes may update the attacker, and the UpAttCTech node may update the attacker_comp. This update may use the expressions from the lines 24, 25, 18, 7, 6, 5, 3, and 11 in Listing 510 of FIG. 5B. The code here may align with lines 9-11 in Algorithm 520 of FIG. 5C:

```
eq attacker : Attack_AGREE_Models : : ATTACKER =
  Attacker_AGREE_Types : : CYBERATTACKER ->
  if (t1 and t1_ud=2) then
    CADA_Nodes : : UpAttTech(
      attacker,
      A_Tech_AGREE_Types : : CAPEC565_POST)
  else if (t2 and t2_ud=2) then
    CADA_Nodes : : UpAttTech(
      attacker,
      A_Tech_AGREE_Types : : T0807_POST)
  else pre(attacker);
eq a_cnc_comp : Attack_AGREE_Models : : ATTACKER_COMP =
  Attacker_AGREE_Types : : CNC_SVR_ATTACK ->
  if (t1 and t1_ud=2) then
    CADA_Nodes : : UpAttCTech(
      a_cnc_comp,
      A_Tech_AGREE_Types : : CAPEC565_POST)
    else if (t2 and t2_ud=2) then
    CADA_Nodes : : UpAttCTech(
      a_cnc_comp,
      A_Tech_AGREE_Types : : T0807_POST)
  else pre(a_cnc_comp); .
```

Following AGREE syntax, rich models may be developed using such reasoning by adding expressions (such as modeling many different types of techniques of the attacker and the defender within their sub-clause statements), adding relational dependencies of events within the technique Boolean definitions, or utilizing the state of attackers and/or techniques to update or change the state of the system.

As a simple example of assume/guarantee conditional logic, refer to the flows of information in FIGS. 3A-3B, where the arrows in both the hardware and software models reflect the flow of information between components. Assuming that each of these arrows may be represented by a simple Boolean value reflecting that their contents have not been manipulated by an attack, the following syntax may provide simple assume (input) and guarantee (output) checks after the attack path defined above, which may be added to CADA at the component- and top-layers of the model.

For the component level, these assume/guarantee statements may show that the Boolean values associated with data flows pertaining to the two inputs and two outputs declared within the CNC server component remain true. For example, these statements may use the AGREE sub-clause syntax found in lines 2 and 3 in Listing 500 of FIG. 5A, along with expressions 7, 6, and 5 in Listing 510 of FIG. 5B:
assume “Command input not compromised”:

$$cmd\_in = true ;$$

assume “SSH command input not compromised”:

$$SSHInterface = true ;$$

guarantee “Motion Control output not manipulated”:

$$mot\_cmd \_out = true ;$$

guarantee “IO Control output not manipulated”:

$$io\_cmd \_out = true ;$$

At the model's top-layer system component, there may be a similar Assume statement that may be triggered if the ATT&CK technique T0835 (Manipulate I/O Image) is executed by the attacker. This statement may use the AGREE sub-clause syntax found in lines 2 in Listing 500 of FIG. 5A, along with expressions 7, 25, 18, 23, and 12 in Listing 510 of FIG. 5B:

```
assume “Manipulation of Control has not occurred” :
  linuxcnc_cmd_in =
    if (CNC_T0835 = true and CNC_T0835_ud > 1)
      then false
    else prev (linuxcnc_cmd_in, true); .
```

The T0835 event may require that the attacker gain command line access first, which can be accomplished through the techniques added previously. Then, through T0835, the attacker may change the LinuxCNC server's Hardware Abstraction Layer (HAL) file as the last step in their attack. This is an example of a simple safety violation, because if the LinuxCNC server is manipulated through its use of the HAL file then the CNC machine may fall under the attacker's control. The result is T0831 (Manipulation of Control), which is the Red Cell's objective.

The Red Cell may now proceed to test running techniques in CADA. The assume-guarantee statements at the component- and top-layers can represent the statements that may be checked by the model checker. The Red Cell may have utilized the CYBERCRIMINAL and CNC_SVR_ATTACK objects to describe the attacker's knowledge, resources, and psychology as well as the techniques CAPEC-565 (Password Spraying) and T0807 (Command Line Interface). The initialized values of these techniques and attack profiles are provided in Tables 3A-3B. From the assume/guarantee statements, when the model checker identifies the path that ends in T0835 (Manipulate I/O Image), it is expected to identify a counterexample including the trace of the attacker's steps. This trace output may provide sufficient information to create all steps taken by the attacker to reach the Red Cell's objective, if the full path was defined.

Alternatively, the Red Cell may elect to use AGREE and test the mutual exclusivity of running the two techniques, CAPEC-565 (representing a password spray attack) and T0807 (Command Line Interface access). The Red Cell may change the top-layer assumption from (CNC_T0835=true and CNC_T0835_ud>1) to (CNC_T0807=true and CNC_T0807_ud >1) to test the mutual exclusivity and ordering of the two techniques. The results are shown for each time step in Table 4.

TABLE 4
Objects at different time steps.

| | CYBERCRIMINAL | | | | CNC_SVR_ATTACK | | | |
|---|---|---|---|---|---|---|---|---|
| Time Step: | 0 | 1 | 2 | 3 | 0 | 1 | 2 | 3 |
| xₒₖ | 25 | 25 | 25 | 25 | — | — | — | — |
| xₚₒₖ | 0 | 0 | 0 | 0 | — | — | — | — |
| xₙₒₖ | 25 | 25 | 25 | 25 | — | — | — | — |
| xₛₒₖ | 25 | 25 | 25 | 25 | — | — | — | — |
| x_{ck} | — | — | — | — | 75 | 75 | 75 | 75 |
| xₚₖ | — | — | — | — | 25 | 25 | 25 | 60 |
| x_{sck} | — | — | — | — | 50 | 50 | 50 | 60 |
| x_{crk} | — | — | — | — | none | none | User | User |
| x_{dr} | near | near | near | near | — | — | — | — |
| xₘᵣ | low | low | low | low | — | — | — | — |
| xₜᵣ | basic | basic | basic | basic | — | — | — | — |
| x_{fr} | 10000 | 10000 | 9900 | 9800 | — | — | — | — |

Table 4 shows the sequenced time steps through a counterexample identified by AGREE to the modified assume statement triggered when T0807 occurs. At time step 1, no update has been made to the attacker (CYBERCRIMINAL) and attacker_comp (CNC_SVR_ATTACK) objects, because no technique has yet completed where their semaphore counter is set to 2 (signaling the technique was run, as described above). At time step 2, the attacker and attacker_comp objects are updated using the values from the first time step, signaling that the model checker selected CAPEC-565 to run first and it ran in the previous time slot. The User credential is copied from CAPEC565_PWD_SPRAY_POST to the attacker_comp object, as it was identified during the password spray attack. At time step 3, updates to the attacker and attacker_comp objects are made from the T0807_CLI_POST object representing its run in the previous time slot at time step 2. It is worth pointing out that due to k-induction, the attacker received the CNC server's User credential at time step 2 from the completion of a password spray attack against the CNC server, and then they immediately used that credential in the same time slot to access the command line interface (T0807).

As both techniques were successfully executed in a mutually exclusive manner using the refined logic described above, understanding the logic from this exercise may allow the Red Cell to build more interesting attack paths by sequencing various techniques. As similar logic may be used for running the defender's techniques, the Blue Cell may be able to take a similar approach when it is their turn to model defenses.

In some embodiments, Attack-Defense Trees (ADTrees) may provide a simple structure for the Red and Blue Cells to begin planning their various strategies to incorporate into the model. For example, through a review of the CNC system model developed earlier in FIGS. 3A-3B, the Red Cell and Blue Cell can conduct a tabletop exercise where they take turns identifying attacks and defenses against the LinuxCNC-based system. For example, attacks can focus on targeting the CNC system from the cyber layer of the system. The proponent for this model may be the attacker, and they are attempting to manipulate control of the physical CNC processes through ATT&CK Technique T0831. The attack may start with a network scan (T0846) to identify either the CNC server or the motor controller on the network. The attacker then may have a choice to attack either controller.

If the attacker chooses to target the CNC server, there may be four sequential attack actions that may all be successful. First, the attacker may identify the public-facing SSH server on the network (T1190). Then, the attacker may conduct a password attack, where two options are provided-a dictionary attack (CAPEC-16) or a password spray attack (CAPEC-565). Assuming the attacker obtains a credential, they may then gain command-line access through the SSH service (T0807) and then may complete the attack chain by modifying the LinuxCNC HAL image (T0835) to change the way LinuxCNC interfaces with the CNC hardware, completing the attack chain.

In the case of the CNC server, the Blue Cell may identify a few options to stop the attack chain. Focusing on the SSH service, the defender may have three choices. They may either (1) update network ACLs to limit which devices communicate to the LinuxCNC server over SSH (NIST 800-53 Rev. 5 control SC-7 (5)), or (2) they may implement multi-factor authentication within the LinuxCNC server (control IA-2 (6)), or (3) they may monitor the network traffic for anomalous connections (D3FEND D3-CAA) and then implement traffic filtering on the local network (D3-ITF). The attacker may be able to bypass the network ACLs, so options (2) and (3) may be better recommendations. The defender may also be able to sign the LinuxCNC HAL (CM-14) which may ensure it was not manipulated to stop the last step of the SSH attack chain.

If the attacker chooses to target the motor controller on the network, three sequential steps may be identified as part of this process. The Motor Controller may be assumed to have a listening service for firmware updates, which the attacker may be looking to exploit. As there may be many motor controllers on the market, the attacker may have to identify the correct controller and then conduct research on its update process (T1592.003). Then the attacker may create an exploit directed at the firmware update service (T0866). Finally, the attacker may upload their malicious firmware to the motor controller (T0839) to complete this attack chain.

For the motor controller, the Blue Cell may focus on similar strategies as they did with the LinuxCNC server. At the network layer, they may have two choices which may be similar to their previous network defenses since they may not be able to modify the firmware update service on the motor controller. They may either (1) update network ACLs to limit which devices communicate to the motor controller's firmware update service (SC-7 (5)), or (2) they may monitor the network traffic for anomalous connections (D3FEND D3-CAA) and then implement traffic filtering on the local network (D3-ITF). Again, the attacker may bypass the network ACLs, if they choose. Finally, they may be able to require the motor controller to only use signed firmware to prevent the attack chain, which has become a requirement for this component selection.

The Red Cell also decided to focus attacks on the physical layer. These attacks may require someone with insider or physical access to conduct the changes, which may be a different attack profile than the CYBERATTACKER that was previously considered. The attacker may have a choice to change the configuration within any of the motor drive controllers or the spindle's VFD leveraging CAPEC-401 to manipulate physical control of the CNC system. At this time, the Blue Cell may not have identified any countermeasures to these physical attacks.

In some embodiments, in order to model the CNC server attack path, the Red Cell may assume that weaknesses (vulnerabilities) are present within the CNC server component, but may add them to the AADL component model so that the techniques only run when they are present. Similarly, to stop this attack path, the Blue Cell may add security controls and collect a network artifact using the model, and the presence of these items may also be added to their respective AADL component models. The following describes how to add these elements.

For the attack path, the Red Cell may perform the following steps to assign associated vulnerabilities to the CNC server component and create technique dependencies:
W1: In a separate AADL package, property sets may need to be created to associate weaknesses with components before they may be added within their AADL type declaration. Assume there is a package called Weakness_Props for this model. A property CWE309_prop representing CWE-309 (Use of Password System for Primary Authentication) may be declared as an aadlboolean type and applied to system components, as follows:
   CWE309_prop: addlboolean applies to (system);.
W2: Properties may be associated with AADL component types in their declaration. In this case, CWE309_prop may be declared as a Boolean property within the CNC server component of the model, and it may be initialized as true symbolizing the weakness is present. This command may associate the weakness with the component, as follows:
   properties
      Weakness_Props::CWE309_prop=>true;.
W3: Within the AGREE annex of the CNC server component type, a CWE309 weakness may be declared, and its present value may be initialized to the component property CWE309_prop. It may also be associated pre and post techniques may be assigned to CAPEC-565 (Password Spray Attack), as follows:

```
eq CWE309 : Component_AGREE_Models : : WEAKNESS =
  Component_AGREE_Models : : WEAKNESS {
    present = Get_Property(this,
      Weakness_Props : : CWE309_prop);
    pres = A_Tech_AGREE_Types : : CAPEC565_PRE;
    post = A_Tech_AGREE_Types : : CAPEC565_POST
  }; .
```

W4: As the attacker and attacker_comp may be declared along with their techniques at the top-layer of the model, the weakness declared at the component-layer may need to be raised to the top of the model. To do this, first a weakness object, CNC_svr_CWE309, may be declared within the AGREE annex of the top-layer system component type, as follows:
   eq CNC_svr_CWE309:Component_AGREE_Models::WEAKNESS;
W5: With the CNC_svr_CWE309 weakness declared in the AGREE annex, it may need to be assigned to the CNC_Server subcomponent's weakness, declared in W3. This assignment may occur within the AGREE annex of the top-layer system component implementation, as follows:

$$assign CNC\_svr \_CWE309 = CNC\_Server . CWE 309.$$

W6: Referring to the t1 previously declared, update this t1 Boolean to only run if its associated CNC_svr_CWE309 weakness is present within the CNC server component and to check the requirements from its associated pre technique, as follows:

```
eq t1 : bool = false - >
  if (pre(t1) = true) then true
  else if (CNC_svr_CWE309.present and t1_ud_sp) then
    CADA_Nodes : : CAttT(attacker, a_cnc_comp,
      CNC_svr_CWE309.pre)
  else pre(t1); .
```

After performing W1-W6 above, the attacker and attacker_comp objects may also be updated to incorporate the post technique from CNC_svr_CWE309. Similarly, for working with security controls, the Blue Cell performed similar steps to W1-W6 above, but this time to assign a security control to the CNC server, which may be tied to the attacker's t1 in step [SC6]:
SC6: The resulting CNC_SVR_Con_IA_2_6 security control may be declared in the AGREE annex at the top-layer system component and represents IA-2 (6) from NIST SP 800-53 Rev. 5. This may be a simple Boolean value that signifies whether or not multi-factor authentication may be implemented within the CNC server's SSH server, and may be used to update t1 to not run if it is enabled, as follows:

```
eq t1 : bool = false - >
  if (pre(t1) = true) then true
  else if (CNC_svr_CWE309.present and t1_ud_sp
    and not CNC_SVR_Con_IA_2_6.enabled) then
    CADA_Nodes : : CAttT(attacker, a_cnc_comp,
      CNC_svr_CWE309.pre)
  else pre(t1); .
```

To generate a network intrusion artifact, the Blue Cell may utilize similar logic in AGREE to set the artifact's generate property to true when the Red Cell's t1 technique becomes true when they conduct a password spray attack. When generate becomes true, this may be tied to a technique for a defensive incident response analyst to review the alert and possibly respond accordingly. These example steps may provide ways to tie attacker and defender steps more directly to the components within the model. Thus, the model checker may utilize CADA's weakness, security control, and artifact models to allow the Red and Blue Cells to take advantage of their environments, as well as counter their opponent's moves and consider other approaches towards achieving their objectives.

To execute the game-theoretic state updates and mathematically compute state transitions at each time step, the executable logic nodes can distinguish between a variable's current state and its subsequent state. Because formal verification engines (such as a k-induction solver) cannot simply “overwrite” a variable in memory during a mathematical proof, the library can employ state-transition suffixes, such as_ud and_up_sp. For example, the suffix_ud (Updated) may be appended to a technique or actor variable to represent the calculated “next state” of that entity after an executable logic node has been applied (e.g., transitioning from ATT_T1190 to ATT_T1190_ud after an update node calculates that the attacker successfully gained access). Similarly, the suffix_up_sp (Updated Security Property/Updated System Property) may be appended to system-level variables. If a defensive node successfully mitigates an attack by closing a port, the logic node computes the transition and stores the new defensive posture in the_up_sp variation of the control variable (e.g., Con_SC_7_5_up_sp). This bifurcated variable structure can allow the verification checker to mathematically prove the progression of the adversarial game from time step t to time step t+1 without logic collisions.

During the execution of the formal proof, the verification checker can evaluate the symbolic state space over a series of discrete time steps. To manage concurrent actions and prevent logic collisions between multiple potential actor behaviors, the executable logic nodes may utilize semaphore variables. In some embodiments, the counterexample trace generated by the verification checker may demonstrate execution latency and game-theoretic causality, wherein an attacker technique executed at a first time step dynamically generates a digital artifact at a second time step, which subsequently satisfies a prerequisite condition to trigger a defender technique at a third time step.

In some embodiments, the techniques for both attackers and defenders may be integrated into the model by the White Cell, for example, using Attack-Defense Trees as a reference. For example, a guarantee statement at the top-layer was created to find a counterexample where the defender may respond to an attack by updating the firewall to evict the attacker from the network.

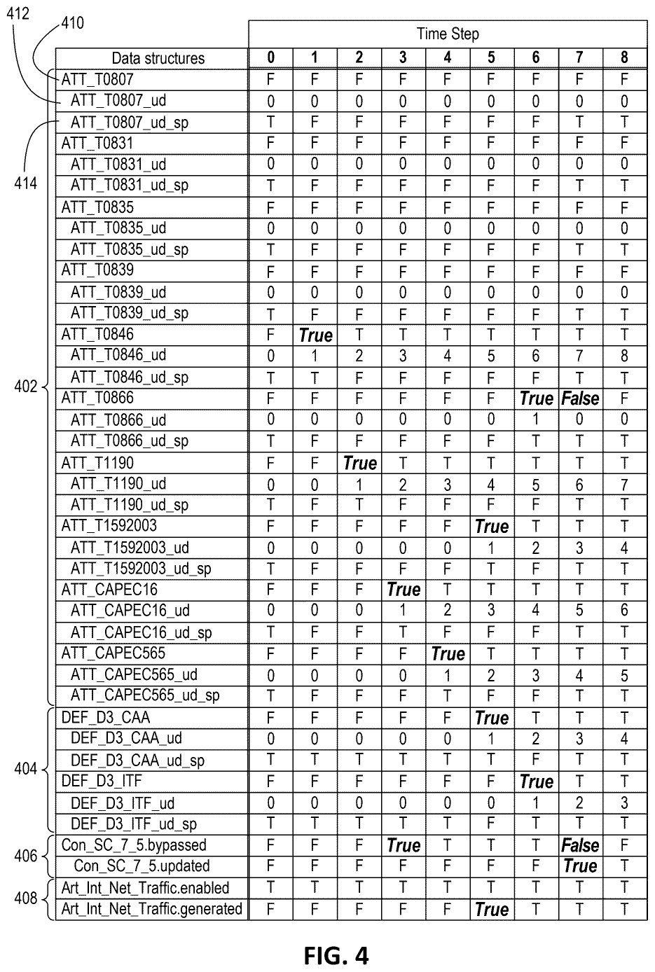

FIG. 4 shows the results of one series of attacker and defender paths identified as the counterexample by the model checker, which may be described as follows. The first row may represent the time step, and all underlying rows representing attacker specific data structures 402 (e.g., attacker techniques (ATT_<name>) as well as their P (ATT_<name>_ud) and V (ATT_<name>_ud_sp) semaphore representations, for example, base technique 410, the corresponding P semaphore representation 412, and the corresponding V semaphore representation 414), defender specific data structures 404 (e.g., defender techniques (DEF_<name>) as well as their respective P (DEF_<name>_ud) and V (DEF_<name>_ud_sp) semaphore representations), security control data structures 406 (e.g., controls (Con_<name>)), and artifact data structures 408 (e.g., artifacts (Art_<name>)).

In FIG. 4, when time=1, the attacker may perform T0846 (Remote System Discovery) to scan the local network. At time=2, the attacker may decide to perform T1190 (Exploit Public-Facing Application) when they find the SSH server running on the CNC server. At time=3, the attacker may bypass security control SC-7(5), representing a firewall, and conducts CAPEC-16 (Dictionary-based Password Attack) to try to find a credential for the CNC server's SSH service. At time=4, the attacker may have been unable to find a credential using the dictionary attack, and attempted CAPEC-565 (Password Spraying) to try another set of passwords to access the CNC server via SSH. At time=5, an internal network artifact may be generated, triggering the defender to conduct CAA (Connection Attempt Analysis). Meanwhile, the attacker may have moved on from the CNC server and uses T1592.003 (Gather Victim Host Information: Firmware) to attempt to study and identify the motor controller device previously identified from the T0846 network scan. At time=6, the defender may respond through ITF (Inbound Traffic Filtering) and begins work to update the firewall and remove the intruder, while the attacker may run T0866 (Exploitation of Remote Services) to begin interacting over the network with the motor controller update service. Finally, at time=7, the defender may update the firewall, represented by security control SC-7(5), and may evict the attacker from the network.

Note that because the defender may have responded and evicted the attacker from the network in a timely manner, the attacker may have been unable to meet their objective and perform T0831 (Manipulation of Control) in this run of the model. However, without the defensive response, the model checker may have found another counterexample where the attacker may still manipulate the firmware of the motor controller. Adding additional security controls to the motor controller's firmware, through signing the firmware, may prevent this attack in the event that the defender is not quick enough to respond.

### CONCLUSION

Any of the features illustrated or described herein, for example, with respect to FIGS. 1A-5C, can be combined with any other feature illustrated or described herein, for example, with respect to FIGS. 1A-5C to provide systems, devices, modules, methods, aspects, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. Applicants therefore claim all that comes within the scope and spirit of these claims.

1. A security assessment method comprising:
providing an architectural model of a system comprising a plurality of components, the architectural model comprising communication interfaces, connections between the components, and one or more specifications, wherein at least one aspect of the one or more specifications is a behavior specification for security of the system;
providing a security verification library comprising a plurality of data structures that define actor profiles, techniques, and executable logic nodes for computing state transitions;
receiving annotations for the architectural model with one or more selections from the security verification library; and
evaluating the annotated architectural model to assess security of the system, the evaluating including verifying the annotated architectural model with respect to the one or more specifications using a verification checker that executes a formal proof over a symbolic state space of the annotated architectural model.

2. The security assessment method of claim 1, wherein the system is a cyber-physical system (CPS) comprising at least one hardware component and at least one software component, and at least some of the connections in the architectural model are data connections representative of a design of the CPS.

3. The security assessment method of claim 2, wherein:
the CPS includes at least one controller and at least one actuator; and
at least some of the data structures in the security verification library include data structures with quantified variables for knowledge, resources, psychology, and capabilities of a threat actor attempting to attack one or more components of the CPS.

4. The security assessment method of claim 2, wherein at least another aspect of the one or more specifications is a specification for safety of the CPS, and the evaluating the model simultaneously assesses safety of the CPS.

5. The security assessment method of claim 1, wherein each specification is configured as a contract, and the architectural model is configured using Architectural Analysis and Design Language (AADL).

6. The security assessment method of claim 5, wherein the security verification library is configured as an AADL extension comprising an Assume-Guarantee Reasoning Environment (AGREE) annex.

7. The security assessment method of claim 5, wherein the verification checker comprises a k-induction based model checker.

8. The security assessment method of claim 1, wherein at least some of the data structures in the security verification library provide a deterministic translation of actor behaviors into mathematical or logical constraints.

9. The security assessment method of claim 1, wherein the formal proof determines that violation of the one or more specifications is logically impossible for the one or more selections.

10. The security assessment method of claim 1, wherein the data structures of the library include data structures defining:
a threat actor profile;
one or more first preconditions for performing a specific first action by the threat actor profile;
one or more first characteristics obtained after performing the specific first action by the threat actor profile;
a defensive actor profile;
one or more second preconditions for performing a specific second action by the defensive actor profile;
one or more second characteristics obtained after performing the specific second action by the defensive actor profile; and
a security property of one of the components.

11. The security assessment method of claim 1, wherein:
at least some of the data structures of the security verification library provide formalized behavior specifications that define tactics, techniques, and procedures of a threat actor or defensive actor in logic; and
the verification checker verifies the architectural model by performing a game-theoretic state update for each actor in the annotated architectural model at each time step.

12. The security assessment method of claim 1, further comprising:
modifying the annotated architectural model based at least in part on the evaluating; and
further evaluating the modified, annotated architectural model to further assess security of the system, the further evaluating including verifying the modified, annotated architectural model with respect to the one or more specifications via the verification checker.

13. A security assessment system comprising:
one or more processors;
one or more databases storing a security verification library comprising a plurality of data structures that define actor profiles, techniques, and executable logic nodes for computing state transitions; and
one or more non-transitory media storing computer-readable instructions that, when executed by the one or more processors, cause the one or more processors to:
receive an architectural model of a system comprising a plurality of components, the model comprising communication interfaces, connections between the components, and one or more specifications, wherein at least one aspect of the one or more specifications is a behavior specification for security of the system;
receive input annotating the architectural model with one or more selections from the stored security verification library; and
verify the annotated architectural model with respect to the one or more specifications by executing a formal proof over a symbolic state space of the annotated architectural model.

14. The security assessment system of claim 13, wherein each specification is configured as a contract, the architectural model is configured using Architectural Analysis and Design Language (AADL), and the security verification library is configured as an AADL extension comprising an Assume-Guarantee Reasoning Environment (AGREE) annex.

15. The security assessment system of claim 13, wherein the verifying employs a k-induction based model checker.

16. The security assessment system of claim 13, wherein the one or more processors verify the annotated architectural model by performing a game-theoretic state update for each actor in the annotated architectural model at each time step.

17. The security assessment system of claim 13, wherein the one or more non-transitory media store further computer-readable instruction that, when executed by the one or more processors, further cause the one or more processors to:
receive one or more modifications of the annotated architectural model after the verifying; and
further verify the modified, annotated architectural model with respect to the one or more contract-based specifications by executing another formal proof over the symbolic state space of the modified, annotated architectural model.

18. One or more non-transitory computer readable media storing a security verification library comprising:
a plurality of data structures defining actor profiles, techniques, and executable logic nodes for computing state transitions,
wherein the security verification library is configured for use in annotating and evaluating an architectural model of a system comprising a plurality of components, the model comprising a behavior specification for security of the system.

19. The one or more non-transitory computer-readable media storing the security verification library of claim 18, wherein:
the architectural model is configured using Architectural Analysis and Design Language (AADL); and
the security verification library is configured as an AADL extension comprising an Assume-Guarantee Reasoning Environment (AGREE) annex.

20. The one or more non-transitory computer-readable media storing the security verification library of claim 18, wherein the plurality of data structures are stored as a hierarchy comprising:
a first set of atomic data structures defining quantitative properties;
a second set of record structures aggregating one or more of the atomic data structures into entity definitions; and
a third set with named constants instantiating one or more of the record structures with predetermined values corresponding to specific security standards.
